(19) United States
(12) Patent Application Publication
(10) Pub. No.: US 2013/0027634 A1
(43) Pub. Date: Jan. 31, 2013

(54) LIQUID CRYSTAL DISPLAY DEVICE

(71) Applicants: Ryuji SANETO, Minami-Ashigara-shi (JP); Hajime NAKAYAMA, Minami-Ashigara-shi (JP); Katsumi SASATA, Minami-Ashigara-shi (JP); Rikio INOUE, Minami-Ashigara-shi (JP)

(72) Inventors: Ryuji SANETO, Minami-Ashigara-shi (JP); Hajime NAKAYAMA, Minami-Ashigara-shi (JP); Katsumi SASATA, Minami-Ashigara-shi (JP); Rikio INOUE, Minami-Ashigara-shi (JP)

(21) Appl. No.: 13/560,076

(22) Filed: Jul. 27, 2012

(30) Foreign Application Priority Data
Jul. 28, 2011 (JP) 2011-166058

(51) Int. Cl. G02F 1/13357

(52) U.S. Cl. 349/62

(57) ABSTRACT

There is provided a liquid crystal display device including: a liquid crystal cell sandwiched between a pair of absorption type polarizing plates; a reflection type polarizing plate; a phase difference film; a light collecting sheet; and a surface light source, wherein the liquid crystal cell sandwiched between a pair of absorption type polarizing plates, the reflection type polarizing plate, the phase difference film, the light collecting sheet, and the surface light source are disposed in this order from a display surface side, and the phase difference film has a λ/4 function and the light collecting sheet is formed of a refractive index isotropic material.

### CROSS-REFERENCE TO RELATED APPLICATION(S)

The present application claims priority from Japanese Patent Application No. 2011-166058 filed on Jul. 28, 2011, the entire content of which is incorporated herein by reference.

### BACKGROUND

1. Field

The present invention relates to a liquid crystal display device.

2. Description of the Related Art

A liquid crystal display device has a major drawback in that the light use efficiency thereof is low, but Japanese Patent Application Laid-Open No. 6-51399 and Japanese Patent Application Laid-Open No. 6-324333 suggest a method for improving luminance intensity by using a reflection type polarizing film between an absorption type polarizing plate at a light source side and the light source. The reflection type polarizing film has a property of transmitting one polarized component and reflecting the other polarized component. Before one of the polarized components of light from the light source is absorbed in the absorption type polarizing plate, the polarized component may be reflected back to the light source and depolarized to reutilize the light. Accordingly, the light use efficiency may be improved.

Furthermore, Japanese Patent Application Laid-Open No. 63-168626 suggests a method for improving the light use efficiency by disposing a phase difference film having a phase difference of ¼ wavelength between a light source and a polarized light reflecting plate. This is a method for transmitting a reflection type polarizing plate by allowing a light to transmit a phase difference film reciprocally and to rotate a plane of polarization at 90° before a polarized light component reflected by a reflection type polarizing plate is reflected from a member at light source side and enters the reflection type polarizing plate again. In this method, the number of reflections for light reuse, the reflections which occurs between the light source and the reflection type polarizing plate may be reduced, as compared to the above-described case where the polarized light is depolarized, and thus, the loss caused by absorption or scattering may be decreased, and accordingly, the light use efficiency may be further increased.

However, in the case of Japanese Patent Application Laid-Open No. 63-168626, a configuration that the reflectance is high and depolarization has not occurred is realized by disposing a mirror as a reflecting member, but members such as a light collecting sheet or a light guide plate and a diffusing plate are required in a light source of a liquid crystal display device, and thus, a mirror cannot be disposed adjacent to a phase difference film. Hence, depolarization occurs when polarized light passes through various members, and thus, there was a problem in that an effect of improving the light use efficiency by a phase difference film could not be sufficiently obtained.

The present invention has been made in order to solve the above-described problem, and an object thereof is to provide a liquid crystal display device having a high light use efficiency.

### SUMMARY

(1) A liquid crystal display device including: a liquid crystal cell sandwiched between a pair of absorption type polarizing plates; a reflection type polarizing plate; a phase difference film; a light collecting sheet; and a surface light source, wherein the liquid crystal cell sandwiched between a pair of absorption type polarizing plates, the reflection type polarizing plate, the phase difference film, the light collecting sheet, and the surface light source are disposed in this order from a display surface side, and the phase difference film has a λ/4 function and the light collecting sheet is formed of a refractive index isotropic material.

(2) The liquid crystal display device according to (1), wherein the light collecting sheet including: a transparent support; and a light collecting layer, wherein an in-plane retardation Re (550) of the transparent support at a wavelength of 550 nm is 20 nm or less.

(3) The liquid crystal display device according to (2), wherein the light collecting layer has a refractive index of 1.55 or more.

(4) The liquid crystal display device according to (1), wherein a retardation Rth

(550) in a thickness direction of the phase difference film is from −90 nm to 90 nm.

(5) The liquid crystal display device according to (1), wherein at least one surface of the phase difference film has a random unevenness.

(6) The liquid crystal display device according to (5), wherein the random unevenness of the phase difference film has an average tilt angle θa of from 2° to 5°.

(7) The liquid crystal display device according to (1), wherein when measuring the amount of light exiting from a backlight unit including the reflection type polarizing plate, the phase difference film, the light collecting sheet and the surface light source, with respect to the normal line of a display screen of the liquid crystal display device, an average value of the amounts of light at an exit angle in the range of from 50° to 85°, which is inclined to the vertical direction or horizontal direction when the liquid crystal display screen is visually recognized by an observer, is 12% or less based on the amount of light in the direction of the normal line.

8) The liquid crystal display device according to (7), wherein each of the absorption type polarizing plates include a polarizing film sandwiched by two protective films, at least one of the protective films which are provided between the liquid cell and the polarizing films of the absorption type polarizing plates is an optically compensatory film, and an in-plane retardation Re (550) of the optically compensatory film, is from 1 nm to 200 nm, and a retardation Rth (550) in a thickness direction is from 80 nm to 400 nm.

(9) The liquid crystal display device according to (7), wherein the liquid crystal cell is in a TN mode.

According to the present invention, a liquid crystal display device having a high light use efficiency may be provided.

### BRIEF DESCRIPTION OF THE DRAWINGS

FIG. 1 is a schematic cross-sectional view of a liquid crystal display device of the present invention.

FIG. 2 is a schematic view illustrating a relationship between a backlight side absorption type polarizing plate and a reflection type polarizing plate.

FIG. 3 is a schematic view illustrating an example of a relationship between a reflection type polarizing plate and a phase difference film.

FIG. 4 is a schematic view illustrating the status when the return light is reflected by a light collecting sheet to reutilize the light.

FIG. 5 is a schematic view illustrating the status when the return light is reflected by a phase difference film to reutilize the light.

FIG. 6 is a cross-sectional view illustrating an optical path in a prism sheet.

FIG. 7 is a schematic view illustrating an example of an apparatus for manufacturing a prism sheet.

FIG. 8 is a schematic view for describing a method for manufacturing a prism sheet.

FIG. 9 is a schematic view for describing a method for manufacturing a prism sheet.

FIG. 10 is a schematic view for describing a method for manufacturing a prism sheet.

FIG. 11 is a schematic view for describing a method for manufacturing a prism sheet.

FIG. 12 is a schematic view for describing a method for manufacturing a prism sheet.

FIG. 13 is a view of a normalized relationship between light intensity and an exit angle based on light intensity (cd) measured at the front surface (0°) with respect to each prism sheet used in the embodiments.

### DETAILED DESCRIPTION

Hereinafter, the present invention will be described in detail. Meanwhile, in the present specification, a numerical range represented by using “to” denotes a range including numerical values described before and after “to” as a lower limit and an upper limit. First, terms used in the present specification will be described.

Re (λ) and Rth (λ) represent an in-plane retardation and a retardation in a thickness-direction at a wavelength of λ, respectively. Re (λ) is measured by irradiating with an incident light at a wavelength of λ nm in the normal direction of the film using KOBRA 21ADH or WR (manufactured by Oji Scientific Instruments Co., Ltd.). In the selection of the measurement wavelength λ nm, measurement may be performed by exchanging a wavelength selective filter manually or converting measured values into a program or the like. When a film to be measured is represented by a uniaxial or biaxial refractive index ellipsoid, Rth (λ) is calculated by the following method.

A total of six points of the Re (λ) are measured by irradiating with an incident light of λ nm in wavelength from each of the inclined directions at an angle increasing in 10° step increments up to 50° in one direction from the normal direction with respect to the normal direction of the film by using the in-plane slow axis (decided by KOBRA 21ADH or WR) as an inclined axis (rotation axis) (when there is no slow axis, any in-plane direction of the film is used as a rotation axis), and then Rth (λ) is calculated by KOBRA 21ADH or WR based on the retardation value measured, a hypothetical value of an average refractive index, and an inputted film thickness value. In the above, in the case of a film having a direction in which a retardation value is zero at a certain inclined angle with the in-plane slow axis from the normal direction being a rotation axis, a retardation value at an inclined angle larger than the inclined angle is changed into a sign of a negative value and then calculated by KOBRA 21ADH or WR. With the slow axis as an inclined axis (rotation axis) (when there is no slow axis, any in-plane direction of the film is used as a rotation axis), retardation values may be measured from any two inclined directions and Rth may be calculated from the following equations (A) and (B) based on the values, a hypothetical value of an average refractive index and an inputted film thickness value.

$$\begin{matrix} [ Eq . 1 ] & \\ Re ( θ ) = [ nx = \frac{( ny \times nz )}{( \sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}} )} ] \times \frac{d}{cos \{ {sin}^{- 1} ( \frac{sin ( - θ )}{nx} ) \}} & Equation ( A )\end{matrix}$$

The above-described Re (θ) represents a retardation value in a direction inclined at an angle (θ) from the normal direction. In Equation (A), nx represents a refractive index in an in-plane slow axis direction, ny represents a refractive index in an in-plane direction perpendicular to nx, and nz represents a refractive index in a direction perpendicular to nx and ny. d represents a film thickness.

Rth=((nx+ny)/2−nz)×d Equation (B)

In the case where a film to be measured may not be represented by a uniaxial or biaxial refractive index ellipsoid, that is, a so-called film having no optic axis, Rth (λ) is calculated by the following method. Eleven points of the Re (λ) are measured by irradiating with an incident light at a wavelength of λ nm from each of the inclined directions at an angle increasing in 10° step increments from −50° to +50° with respect to the normal direction of the film by using the in-plane slow axis (decided by KOBRA 21 ADH or WR) as an inclined axis (rotation axis), and then Rth (λ) is calculated by KOBRA 21ADH or WR based on the retardation value measured, a hypothetical value of an average refractive index, and an inputted film thickness value. In the above-described measurements, the values described in the Polymer Handbook (John Wiley & Sons, Inc.) and catalogues of various optical films may be used as the hypothetical value of the average refractive index. The average refractive index of which value is not known yet may be measured by an Abbe refractometer. The values of an average refractive index of the main optical films are illustrated as follows: Cellulose acylate (1.48), cycloolefin polymer (1.52), polycarbonate (1.59), polymethyl methacrylate (1.49) and polystyrene (1.59). By inputting these hypothetical values of an average refractive index and the film thickness, KOBRA 21 ADH or WR calculates nx, ny and nz. From these calculated nx, ny and nz, Nz=(nx−nz)/(nx−ny) is further calculated.

Meanwhile, in the present specification, the measurement wavelength is 550 nm unless particularly mentioned otherwise.

In the present specification, the angle (for example, an angle such as “90°”) and the relationship thereof (for example, “perpendicular”, “parallel” and “crossing at 45°” and the like) include a range of error allowed in the art to which the present invention pertains. For example, the range means a range within an exact angle±less than 10°, and an error with the exact angle is preferably 5° or less, and more preferably 3° or less.

In the present specification, the surface roughness Ra means an arithmetic average roughness in JIS B 0601 (2001), and the unit thereof is μm unless otherwise specified.

The reflectance means an average reflectance at from 450 nm to 650 nm obtained by mounting an adapter (ARV-474) on a spectrophotometer V-550 (manufactured by JASCO Corporation) to measure a specular reflectance of the exit angle of −5° at the incidence angle of 5° at a wavelength region of from 380 nm to 780 nm.

The present invention relates to a liquid crystal display device in which a liquid crystal cell sandwiched between a pair of absorption type polarizing plate, a reflection type polarizing plate, a phase difference film, a light collecting sheet and a surface light source are sequentially disposed from the display surface side thereof, wherein the phase difference film has a λ/4 function and the light collecting sheet is formed of a refractive index isotropic material.

In a liquid crystal display device using a reflection type polarizing plate between a liquid crystal cell and a surface light source, before one of polarized light components of light from the surface light source is absorbed in an absorption type polarizing plate, the polarized light component may be reflected to return to the light source and depolarized to reutilize the light, and thus, the light use efficiency may be increased. The efficiency for light reutilization may be increased by disposing a phase difference film having a phase difference of λ/4 between the surface light source and the reflection type polarizing plate at an azimuth at which the optic axis thereof forms an angle of 45° with the absorption axis of the absorption type polarizing plate, thereby further increasing the light use efficiency. However, if the light collecting sheet has a large Re value, a polarized light reflected from the reflection type polarizing plate is affected by the phase difference and the polarization direction is changed when the polarized light is reflected from somewhere on the light collecting sheet and the surface light source and incident again on the reflection type polarizing plate, and thus, an effect of improving the light use efficiency by using the reflection type polarizing plate and the phase difference film could not have been sufficiently obtained. The present invention has been made to solve the problem, and the light collecting sheet is formed by using a refractive index isotropic material. When the light collecting sheet includes a transparent support and a light collecting layer, the polarization change during the reutilization of light may be reduced by setting the Re (550) of the transparent support of the light collecting sheet at preferably 20 nm or less, thereby increasing the light use efficiency. Re (550) is more preferably 10 nm or less and even more preferably 5 nm or less.

It is preferred that the light collecting layer of the light collecting sheet has a high refractive index. The refractive index is preferably 1.55 or more, more preferably 1.59 or more, and most preferably 1.70 or more. The amount of light reflected and coming from the reflection type polarizing plate, which the light collecting sheet reflects for reutilization, may be increased by enhancing the refractive index of the light collecting layer, and the efficiency of reutilizing light may be increased accordingly. This is caused by the fact that the angle at which the light incident on the light collecting layer refracts may be increased by enhancing the refractive index of the light collecting layer and the incidence angle on the transparent support may be increased accordingly, thereby increasing the reflectance at the interface between the transparent support and the air.

Hereinafter, several embodiments of the present invention will be described with reference to the drawings, and the relative relationship of the thickness of each layer in the drawings does not reflect the actual relative relationship. In the drawings, the same reference numerals may be given to the same members and the detailed description thereof may be omitted in some cases.

[Liquid Crystal Display Device]

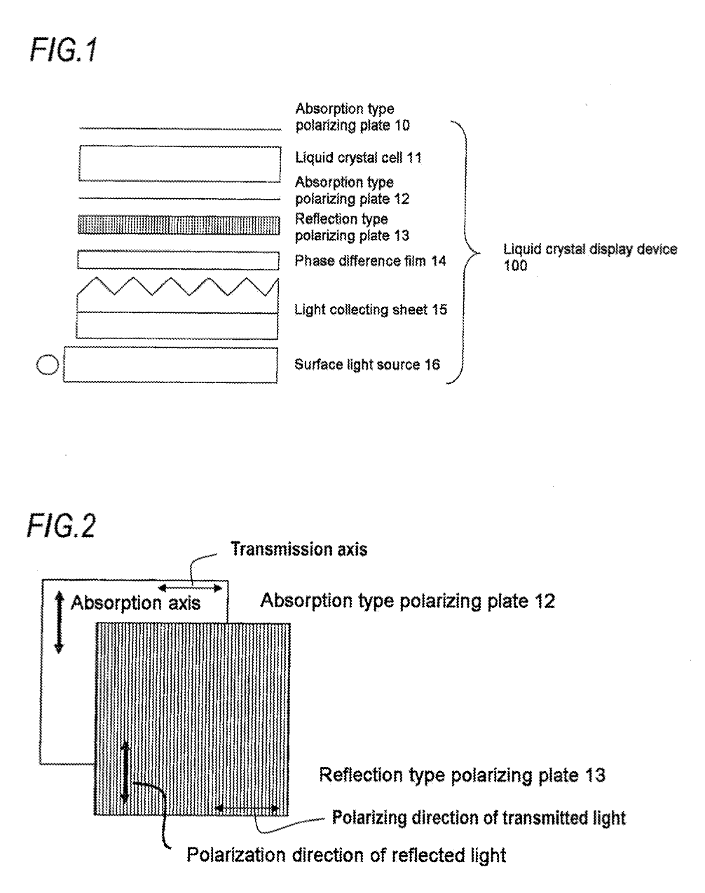

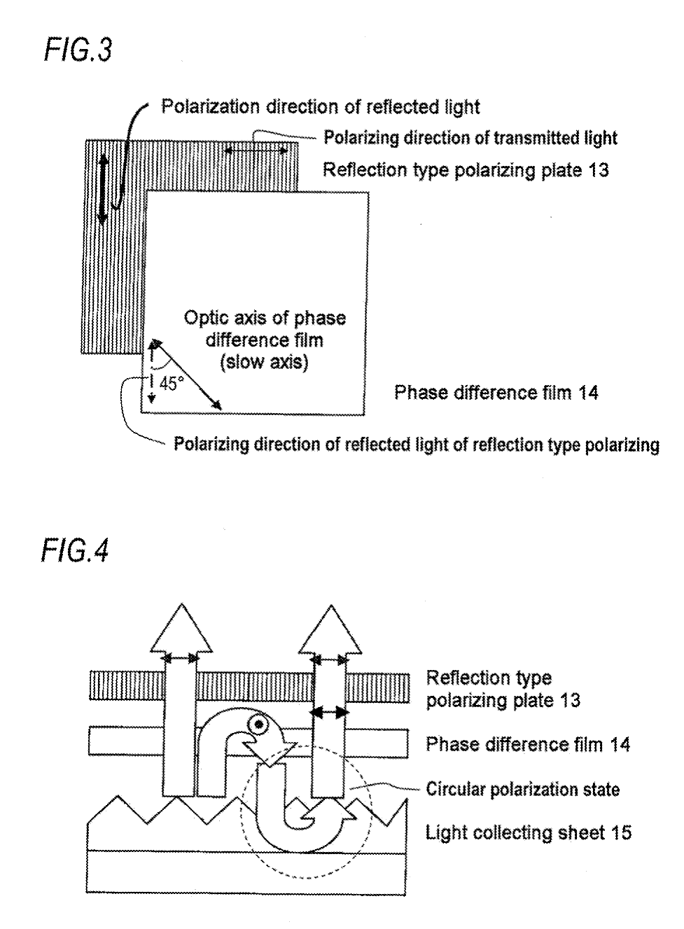

FIG. 1 illustrates a schematic cross-sectional view of an example of a liquid crystal display device of the present invention. A liquid crystal display device 100 has a liquid crystal cell 11 sandwiched between a pair of absorption type polarizing plates 10 and 12, a reflection type polarizing plate 13, a phase difference film 14, a light collecting sheet 15 and a surface light source 16 sequentially from above (from the display surface side thereof). FIG. 2 illustrates an exemplary embodiment of a schematic view of the relationship between the absorption type polarizing plate 12 and the reflection type polarizing plate 13. In FIG. 2, a direction of an absorption axis of the absorption type polarizing plate 12 corresponds to a polarizing direction of a reflected light of the reflection type polarizing plate 13 and a direction of a transmission axis of the absorption type polarizing plate 12 corresponds to a polarizing direction of a transmitted light of the reflection type polarizing plate 13. Light may be reutilized by aligning the absorption axis of the absorption type polarizing plate 12 with the polarization direction of reflected light of the reflection type polarizing plate 13. FIG. 3 illustrates a schematic view of an example of the relationship between the reflection type polarizing plate 13 and the phase difference film 14. In FIG. 3, a linearly polarized light from the reflection type polarizing plate 13, which is incident on the phase difference film 14, may be converted into a circularly polarized light by adjusting an angle between the polarization direction of reflected light of the reflection type polarizing plate 13 and the optic axis (slow axis) of the phase difference film 14 to 45° or 135°.

FIG. 4 is a schematic view illustrating the status that a linearly polarized light reflected from the reflection type polarizing plate 13 is converted into a linearly polarized light perpendicular thereto and transmits the reflection type polarizing plate 13.

Of these polarized light which is entered from a side of the light collecting sheet and transmits the phase difference film 14, the reflection type polarizing plate 13 reflects the only linearly polarized light with a direction perpendicular to a sheet. The reflected linearly polarized light is converted into a circularly polarized light when transmitting the phase difference film 14 again, and the circularly polarized light is reflected from the surface of the support in the light collecting sheet 15 as a circularly polarized light with a revirse polarized direction. After the reflected circularly polarized light transmits the phase difference film 14 again, the reflected circularly polarized light becomes a linearly polarizing light with a direction parallel to the sheet. For this reason, luminance intensity is improved.

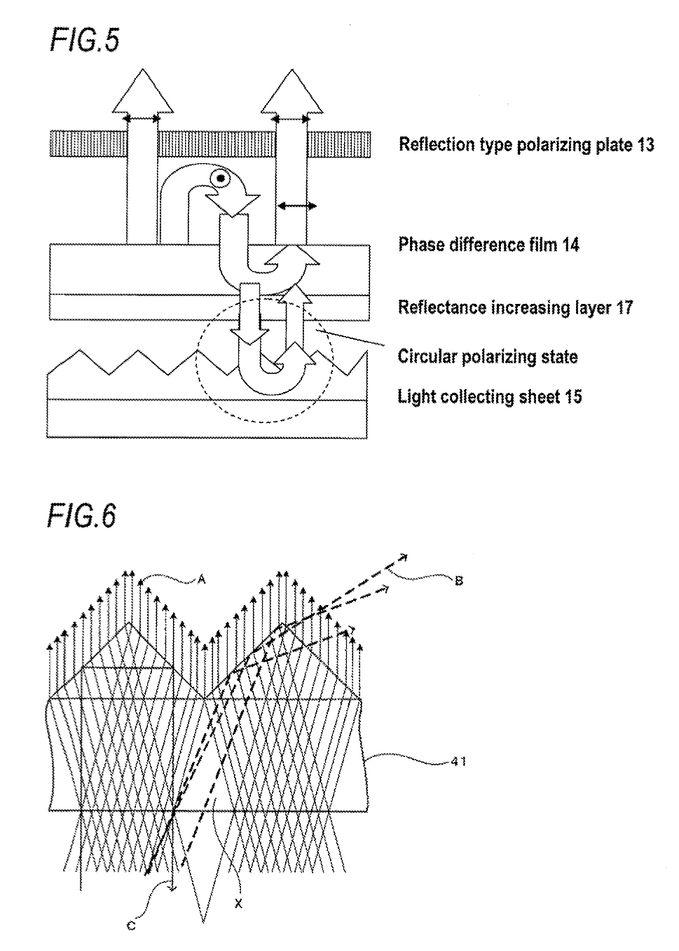

This effect is increased by providing a reflectance increasing layer 17 in the phase difference film 14 (See FIG. 5). The reflectance increasing layer 17 has a function to collect transmitted light by utilizing retroreflection between the light collecting sheet 15 and the phase difference film 14 and a function to effectively reflect a return light from the reflection type polarizing plate 13. Therefore, luminance intensity is more improved.

[Light Collecting Sheet]

As the light collecting sheet 15, a prism sheet or a lens sheet may be used. The light collecting sheet 15 is preferably a sheet having unevenness formed on its surface, and various materials and preparation methods thereof may be used, but in particular, a sheet made of a refractive index isotropic material is preferred for improving the light use efficiency, which is an object of the present invention. As the sheet made of a refractive index isotropic material, a sheet obtained by using a resin sheet with low molecular orientation, e.g., a film having a low refractive index anisotropy, such as a cyclic olefin resin, an acrylic resin, and acetyl cellulose, as a transparent support and forming a light collecting layer thereon with an acrylic resin and the like is preferably used. A sheet, on which unevenness is formed by embossing on the surface of a film having a low refractive index anisotropy such as acetyl cellulose with a mold and the like, is preferably used. Accordingly, the polarization change in light which has passed the light collecting sheet 15 is decreased when light is reutilized, and thus, the light use efficiency may be improved. Also, there is an effect of making it difficult to generate the coloring non-uniformity attributed to the thickness non-uniformity of the transparent support.

As a material used in the transparent support of the light collecting sheet 15, a material having a low photoelasticity is preferred. The generation of non-uniformity may be suppressed by using a material having a low photoelasticity. At a position close to the surface light source, the temperature is high, and a variation in in-plane temperature is large, and thus, stress is readily generated. If the photoelasticity is high, a variation in the phase difference caused by the stress is increased, and thus, the non-uniformity is easily generated. Examples of the material having a low photoelasticity include a cyclic olefin resin, acetyl cellulose, materials using acrylic resins and a low photoelasticity glass.

[Phase Difference Film]

The phase difference film in the present invention has a λ/4 function. Accordingly, a linearly polarized light may be converted into a circularly polarized light.

For the phase difference of the phase difference film 14, the phase difference satisfying the formula λ/4, 3×λ/4 and (1+2n)×λ/4 (n is an integer) may convert the linearly polarized light into the circularly polarized light, which imparts a great effect, and λ/4 is particularly preferred. When the phase difference increases, the phase difference is susceptible to being influenced by wavelength distribution, and thus, a difference in light use efficiency is made at each wavelength, thereby making it easy to generate a rainbow color in-plane non-uniformity.

The in-plane retardation Re (550) of the phase difference film 14 is preferably from 100 nm to 175 nm, more preferably from 110 nm to 165 nm and even more preferably from 115 nm to 155 nm. The retardation Rth (550) in the thickness direction is preferably from −400 nm to 260 nm, more preferably from −200 nm to 160 nm and even more preferably from −90 nm to 90 nm. By adjusting the value of Rth in the range, the light passing through the phase difference film 14 in an inclined direction is also allowed to have an action of converting a linearly polarized light into a circularly polarized light, and thus, the light use efficiency may be increased.

The configuration of the phase difference film 14 is not particularly limited. The configuration may be a single layer structure or a laminated structure. Examples of a member which may be used in the phase difference film 14 include a phase difference polymer film, a laminated body of phase difference films, an optical anisotropic layer formed by fixing the alignment of a liquid crystal composition and a laminated body of the optical anisotropic layer and a polymer film supporting the optical anisotropic layer. Details on these members will be described below.

It is also preferred that the phase difference film 14 has a reflectance increasing layer. The reutilization cycle of light rotating between the reflection type polarizing plate 13 and the phase difference film 14 may be increased by providing a reflectance increasing layer on one surface of the phase difference film 14 such that the surface is disposed to face the light collecting sheet 15 side, thereby increasing the light use efficiency. The reflectance of the phase difference film 14 is preferably from 10% to 30%, and more preferably from 15% to 25%. When the reflectance is too low, the reutilization cycle of light is not increased. When the reflectance is too high, most of the light incident from the surface light source 16 is reflected, and thus the efficiency is rather reduced.

As a method for enhancing the reflectance of one surface of the phase difference film 14, a method for disposing an optical interference layer with a different refractive index on the surface thereof and a thickness of 1 μm or less as a reflectance increasing layer is preferred. Even if the number of layers of a thin film layer constituting the interference layer is one, an effect is obtained. However, a high reflectance may be obtained by having a multilayered configuration to optimize the refractive index and the thickness.

In order to suppress the generation of moire patterns caused by the interference of a periodic pattern between the periodic structure of the light collecting sheet 15 and the pixels of the liquid crystal cell 11, a method for disposing a diffusion sheet between the light collecting sheet 15 and the reflection type polarizing plate 13 has been conducted. However, when a diffusion sheet is further inserted between the member configurations in the liquid crystal display device 100 shown in FIG. 1, the air interface is increased, and thus, depolarization easily occurs. For that reason, it is preferred to form unevenness on the surface of the phase difference film 14 to have a light diffusion function. Accordingly, a change in polarization caused by reflection at the air interface may be suppressed to enhance the light use efficiency.

The haze value of the phase difference film 14 which is allowed to have a light diffusion function is preferably from 3% to 50%, more preferably from 5% to 30%, and most preferably from 10% to 25%. When the haze value is low, an effect of suppressing the moire patterns may not be obtained. When the haze value is high, the depolarization occurs due to light scattering, thereby making it difficult to obtain an effect of improving the light use efficiency which is an object of the present invention.

As the method for allowing the phase difference film 14 to have a light diffusion function, any method may be used as long as the method is for forming unevenness on the surface thereof, and for example, a method for applying a UV curable resin containing particles to dry the resin and subject the resin to UV light curing, a method for dissolving the surface in a solvent to be embossed with a mold on which unevenness has been formed in advance, a method for mixing particles in a surface layer by using a co-casting method when the phase difference film 14 is prepared and the like may be used.

[Reflection Type Polarizing Plate]

The configuration of the reflection type polarizing plate 13 is not particularly limited. A linear polarizer in which birefringent resins are laminated, a circular polarizer in which a cholesteric liquid crystal and a λ/4 plate are combined, a wire grid type polarizer and the like may be used.

[Surface Light Source]

The configuration of the surface light source 16 is not particularly limited. It is possible to use a light guide plate with a light source disposed on the side surface thereof, a configuration in which light sources are arranged side by side in a planar form and uniformly distributed by a diffusing plate, an organic EL light source emitting light from the surface thereof, and the like. It is also possible to use a surface light source which emits a polarized light. As a surface light emitting light source which emits a polarized light, an organic EL light source with light emitting materials oriented and the like have been suggested.

The light collecting sheet 15 using the refractive index isotropic material used in the present invention may be suitably used even in a light source which surface emits a polarized light. When a polarized light transmits the light collecting sheet 15, a change in polarization direction is small, and thus, the light use efficiency may be increased.

Hereinafter, various members and the like used in the liquid crystal display device of the present invention will be described in detail.

[Material and Preparation Method of Light Emitting Sheet]

Materials constituting the light collecting sheet 15 according to an exemplarly embodiment of the present invention and a preparation method thereof will be described.

Any method for preparing the light collecting sheet 15 according to an exemplarly embodiment of the present invention may be used as long as a prism sheet with a fine unevenness pattern thereon may be formed by the method, and the preparation method thereof is not limited.

For example, it is possible to use a method for preparing a prism sheet, including: pressing a sheet type resin material extruded from a die between a transfer roller (with the reverse pattern of an unevenness pattern to be formed on the prism sheet on the surface thereof) rotating at an approximately the same speed as the extrusion speed of the resin material and a nip roller plate disposed to face the transfer roller and rotating at the same speed to transfer the unevenness pattern of the transfer roller to the resin material and prepare the prism sheet.

It is possible to use a method for preparing a prism sheet, including: laminating a transfer template (stamper) with the reverse pattern of an unevenness pattern to be formed on the prism sheet on the surface thereof and a resin plate by hot press; and subjecting the laminated body to heat transfer to press mold the prism sheet.

It is also possible to use a method for preparing a prism sheet, including: using a flat plate metal mold with the reverse pattern of an unevenness pattern to be formed on the prism sheet to perform an extrusion molding and prepare the prism sheet.

As a resin material constituting the prism sheet used for the above-described preparation methods, thermoplastic resins are used. Specific examples thereof include polymethyl methacrylate resins (PMMA), polycarbonate resins, polystyrene resins, MS resins, AS resins, polypropylene resins, polyethylene resins, polyethylene terephthalate resins, polyvinyl chloride resins (PVC), cellulose acylate, cellulose triacetate, cellulose acetate propionate, cellulose diacetate, thermoplastic elastomers or copolymers thereof; cycloolefin polymers and the like.

As other preparation methods, it is possible to use a method for preparing a prism sheet, including: using an unevenness roller (with the reverse pattern of an unevenness pattern to be formed on the prism sheet on the surface thereof) to transfer an unevenness pattern on the surface of a transparent film and form the prism sheet. Specifically, this is a method for preparing a prism sheet, including: sequentially coating an adhesive and a resin on the surface of a transparent film to form an adhesive layer and a resin layer (for example, a UV curable resin), winding the transparent film around a rotating unevenness roller to continuously feed the transparent film, transferring the unevenness pattern formed on the surface of the unevenness roller to the resin layer, and curing (for example, UV irradiation) the resin layer with the transparent film being wound around the unevenness roller.

Meanwhile, it is not necessary to provide the adhesive layer when the adhesion between the resin layer and the transparent film is fairly good, and examples of a method for improving the adhesion include a method for forming an undercoat layer on the surface of the transparent film, a method for performing an activation treatment such as corona treatment and the like. The method is not particularly limited as long as the adhesion is improved by the method.

There is also a method, including: coating a resin material (for example, a UV curable resin) on an unevenness roller with a reverse pattern of a unevenness pattern formed on a prism sheet formed thereon, sandwiching a continuously advancing transparent film between the unevenness roller and a nip roller to stick together the resin material of the unevenness roller and the transparent film, and then performing curing (for example, UV irradiation) thereon. In order to enhance the adhesion between the resin material and the transparent film, a method for forming the above-described adhesive layer and the like may be used.

[Transparent Support]

A method for preparing a transparent support is not particularly limited. Either a solution film forming method or a melt film forming method may be used. The solution film forming method is preferred. As the transparent support, it is preferred to use a polymer film having a small Re. Specifically, Re (550) of the transparent support is preferably 20 nm or less, more preferably 10 nm or less, further preferably 5 nm or less.

Examples of a material for forming the transparent support which may be used in the present invention include polycarbonate-based polymers, polyester-based polymers such as polyethylene terephthalate and polyethylene naphthalate, acrylic polymers such as polymethyl methacrylate, styrene-based polymers such as polystyrene and acrylonitrile-styrene copolymer (AS resin), and the like. Examples thereof also include polyolefins such as polyethylene and polypropylene, polyolefin-based polymers such as ethylene-propylene copolymer, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, chloride vinylidene-based polymers, vinyl alcohol-based polymers, vinyl butyral-based polymers, arylate-based polymers, polyoxymethylene-based polymers, epoxy-based polymers or polymer mixtures of the above polymers. The transparent support which can be used in the present invention may be formed as a cured layer of acrylic, urethane-based, acryl urethane-based, epoxy-based or silicon-based UV curable or heat curable resins.

As a material for the transparent support, a thermoplastic norbornene-based resin may be preferably used. Examples of the thermoplastic norbornene-based resin include ZEONOR and ZEONEX manufactured by ZEON Corporation, ARTON manufactured by JSR Corporation and like.

As a material for the transparent support, a cellulose-based polymer (hereinafter, referred to as cellulose acylate) represented by triacetyl cellulose, which has been used as a transparent protective film of a polarizing plate in the related art, may be preferably used. Furthermore, a copolymer (COC) formed by a cyclic olefin and anther olefin may be preferably used, for example, TOPAS manufactured by Topas Advanced Polymers GmbH is exemplified.

[Stretching]

The transparent support may be a stretched film which has been subjected to stretching treatment as long as refractive isotropy is satisfied. Retardation and an in-plane slow axis may be adjusted by stretching treatment.

Methods for stretching a film in the width direction (TD direction) positively are described in, for example, Japanese Patent Application Laid-Open Nos. 62-115035, 4-152125, 4-284211, 4-298310, 11-48271 and the like. The stretching of the film is performed at room temperature or under heating conditions. The heating temperature is preferably from −20° C. to +100° C. between which the film has a glass transition temperature. When stretching is performed at a temperature extremely lower than the glass transition temperature, the film is easily broken into pieces, and thus, desired optical characteristics may not be exhibited. When stretching is performed at a temperature extremely higher than the glass transition temperature, a film that is molecular-aligned by stretching is relaxed by heat during the stretching before thermally fixed, and the alignment may not be fixed, and thus, the expression of optical characteristics deteriorates.

The stretching of the film may be performed by uniaxial stretching only in the MD or TD direction, or biaxial stretching in a simultaneous or sequential manner, but it is preferred that stretching is performed much more in the TD direction. The stretching in the TD direction is performed preferably from 1% to 100%, more preferably from 10% to 70%, and particularly preferably from 20% to 60%. The stretching in the MD direction is performed preferably from 1% to 10%, and particularly preferably from 2% to 5%.

The stretching treatment may be performed during the film forming process, and a raw fabric obtained by forming a film and winding the film may be subjected to stretching treatment.

When stretching is performed during the film forming process, stretching may be performed with the residual solvent amount included, and stretching may be performed such that the residual solvent amount=(mass of remaining volatile component/film mass after heat treatment)×100% is preferably from 0.05% to 50%.

When the raw fabric obtained by forming a film and winding the film is stretched, the stretching is performed preferably from 1% to 100% in the TD direction with the residual solvent amount being from 0% to 5%, more preferably from 10% to 70%, and particularly preferably from 20% to 60%.

The stretching treatment may be performed during the film forming process, and then a raw fabric obtained by forming a film and winding the film may be further subjected to stretching treatment.

When the film subjected to stretching treatment during the film forming process is wound and then further subjected to stretching treatment, the stretching during the film forming process may be performed with the residual solvent amount included, and stretching may be performed such that the residual solvent amount=(mass of remaining volatile component/film mass after heat treatment)×100% is preferably from 0.05% to 50%. The stretching of the raw fabric obtained by forming a film and winding the film is performed with the residual solvent amount being preferably from 0% to 5%, and the stretching in the TD direction is performed preferably from 1% to 100% based on the case in which the stretching is not performed, more preferably from 10% to 70% and particularly preferably from 20% to 60%.

The transparent support may be subjected to biaxial stretching as long as refractive isotropy is satisfied.

The biaxial stretching may include a simultaneous biaxial stretching method and a sequential biaxial stretching method, but, the sequential biaxial stretching method is preferred from the viewpoint of continuous preparation. A dope is cast, and then a film is peeled off from a band or a drum and stretched in the TD direction and then stretched in the MD direction, or stretched in the MD direction followed by stretching in the TD direction.

In order to relax the residual strain in the stretching and then reduce a change in dimension, or in order to decrease the variation of the in-plane slow axis toward the TD direction, it is preferred that the film is subjected to transverse stretching and then subjected to a relaxation process. In the relaxation process, it is preferred that the width of the film before the relaxation is adjusted in the range of from 100% to 70% (relaxation rate from 0% to 30%) of the width of the film after the relaxation. The temperature in the relaxation process is preferably from an apparent glass transition temperature of the film Tg−50° C. to Tg+50° C. In normal stretching, in a relaxation rate zone after going through this maximum widening rate, a time until the film passes through a tenter zone is shorter than one minute.

Here, the apparent Tg of the film in the stretching process is obtained by enveloping the film containing the residual solvent in an aluminum pan, raising the temperature from 25° C. to 200° C. at a rate of 20° C./min by means of a differential scanning calorimeter (DSC), and then obtaining a heat absorption curve.

When stretching treatment is carried out during the film forming process, the film may be dried with the film being conveyed. The drying temperature is preferably from 100° C. to 200° C., more preferably from 100° C. to 150° C., even more preferably from 110° C. to 140° C., and particularly preferably from 130° C. to 140° C. The drying time is not particularly limited, but is preferably from 10 min to 40 min.

By choosing an optimal temperature for drying after stretching, the residual stress of the prepared cellulose ester film is relaxed, and the dimensional change, the optical characteristic change and the slow axis azimuth change may be reduced under high temperature and under high temperature and high humidity.

When the raw fabric obtained by forming a film and winding the film is stretched, the film which has been subjected to stretching treatment may be prepared thereafter through a further heat treatment process. It is preferred that by subjecting the film to the heat treatment process, the residual stress of the prepared transparent film is relaxed such that the change in dimensions, the change in optical characteristics and the change in slow axis azimuth are reduced under high temperature and under high temperature and high humidity, and further it tends to realize refractive isotropy. The temperature at the time of heating is not particularly limited, but is preferably from 100° C. to 200° C.

Subsequently, in the prism sheet with a triangular unevenness pattern formed thereon, which has been prepared by the process, a resin material for forming a light collecting layer for obtaining the light collecting sheet 15 according to the present invention will be described.

The resin material for forming the light collecting layer is not particularly limited as long as the material has a predetermined refractive index and physical properties such as viscosity capable of filling up the valley bottom of the concave portion. Specifically, a resin such as a polymethyl methacrylate resin (PMMA), a polycarbonate resin, a polystyrene resin, an MS resin, an AS resin, a polypropylene resin, a polyethylene resin, a polyethylene terephthalate resin, a polyvinyl chloride resin (PVC), cellulose acylate, cellulose triacetate, cellulose acetate propionate, cellulose diacetate, a thermoplastic elastomer or a copolymer thereof; and a cycloolefin polymer may be diluted with a solvent, and the mixture may be introduced into the concave portion to volatilize the solvent. A UV curable resin and the like may be introduced into the concave portion and cured by irradiation of UV light.

When the UV curable resin is used, it is possible to use a product produced by mixing a compound containing the above-described structure and a reactive group such as a (meth)acryloyl group, a vinyl group and an epoxy group with a mixture producing active species such as radicals and cations capable of being reacted with the reactive group-containing compound by irradiation of radiation such as UV. In particular, from the viewpoint of the curing speed, a combination of a reactive group-containing compound (monomer) containing an unsaturated group such as a (meth)acryloyl group and a vinyl group with a photo-radical polymerization initiator producing radicals by light is preferred.

Examples of the (meth)acryloyl group compound include phenoxyethyl (meth)acrylate, phenoxy-2-methylethyl (meth)acrylate, phenoxyethoxyethyl (meth)acrylate, 3-phenoxy-2-hydroxypropyl (meth)acrylate, 2-phenylphenoxyethyl (meth)acrylate, 4-phenylphenoxyethyl (meth)acrylate, 3-(2-phenylphenyl)-2-hydroxypropyl (meth)acrylate, (meth)acrylate of p-cumylphenol which is reacted with ethylene oxide, ethylene oxide-added bisphenol A (meth)acrylic ester, propylene oxide-added bisphenol A (meth)acrylic ester, bisphenol A epoxy (meth)acrylate obtained by epoxy ring-opening reaction of bisphenol A diglycidyl ether and (meth)acrylic acid, bisphenol F epoxy (meth)acrylate obtained by epoxy ring-opening reaction of bisphenol F diglycidyl ether and (meth)acrylic acid, and the like.

As a (meth)acryloyl group compound having a higher refractive index, a compound having an aromatic ring substituted with a halogen group such as Br or Cl is used. Examples of an unsaturated monomer having such a structure include ethylene oxide-added tetrabromobisphenol A (meth)acrylic ester, propylene oxide-added tetrabromobisphenol A (meth)acrylic ester, tetrabromobisphenol A epoxy (meth)acrylate obtained by epoxy ring-opening reaction of tetrabromobisphenol A diglycidyl ether and (meth)acrylic acid, tetrabromobisphenol F epoxy (meth)acrylate obtained by epoxy ring-opening reaction of tetrabromobisphenol F diglycidyl ether and (meth)acrylic acid, 2-bromophenoxy ethyl (meth)acrylate, 4-bromophenoxy ethyl (meth)acrylate, 2,4-dibromophenoxy ethyl (meth)acrylate, 2,6-dibromophenoxy ethyl (meth)acrylate, 2,4,6-tribromophenyl (meth)acrylate, 2,4,6-tribromophenoxy ethyl (meth)acrylate, and the like.

The refractive index of the resin material may also be increased by containing an inorganic fine particle material having a high refractive index. Examples of such an inorganic material having a high refractive index may include TiO₂ (refractive index from 2.2 to 2.7), CeO₂ (refractive index 2.2), ZrO₂ (refractive index 2.1), In₂O₃ (refractive index 2.0), La₂O₃ (refractive index 1.95), SnO₂ (refractive index 1.9), Sb₂O₅ (refractive index: 1.7) and the like. As the fine particle has a smaller particle size, the transparency of the resin material becomes higher, and thus, the particle size is preferably 100 nm or less, more preferably 50 nm or less, and even more preferably 20 nm or less. These inorganic fine particle materials with a high refractive index may be mixed with a typical UV curable resin to be used, and the refractive index of the UV curable resin may be further increased by mixing the materials with the UV curable resin having a high refractive index as described above.

Examples of an introduction method into a concave portion include a method that a liquid for forming a material for filling the valley bottom of the concave portion is thinly coated on the entire surface of the prism sheet to be introduced into the valley bottom of the concave portion, or a method that, using a dispenser and the like, the liquid is introduced into the valley bottom of the concave portion by each line, and the method may be any methods capable of burying the valley bottom of the concave portion to a desired depth.

It is also possible to add a light diffusing function to the light collecting sheet 15 formed. Examples of a method for adding the light diffusing function include a method for including a light diffusing material in the light collecting sheet 15. Examples thereof also include a method for including light diffusing particles composed of beads and the like in the light collecting sheet 15, a method for kneading a resin having a different refractive index, a method for including air and hollow beads and the like. Examples thereof include a method for forming random unevenness on the surface of the light collecting sheet 15 to impart a light diffusing function, by using a method for adhering beads to the surface of the light collecting sheet 15, a method for roughening the surface of the light collecting sheet 15 using a blast treatment such as sandblasting or a plasma treatment, a method for dissolving the surface of the light collecting sheet 15 by impregnation with a solution that dissolves the light collecting sheet 15, and the like.

<<Prism Sheet>>

As a light collecting sheet used in the present invention, a particularly preferred prism sheet will be described in detail.

In the liquid crystal display device of the present invention, when the amount of light exiting from a backlight unit composed of the reflection type polarizing plate, the phase difference film, the light collecting sheet and the surface light source is measured, with respect to the normal line of a display screen of the liquid crystal display device, the average value of the amounts of light at an exit angle in the range of from 50° to 85° (polar angle of from 50° to) 85°, which is inclined to the vertical direction when the liquid crystal display screen is visually recognized by an observer, is preferably 12% or less based on the amount of light in the direction of the normal line.

FIG. 6 is a cross-sectional view illustrating the optical path in a prism sheet 41. As illustrated in FIG. 6, the incident light is divided into a component A refracting in the direction of the front surface, a component B refracting in the direction of being apart from the front surface rather than in the direction of the front surface and a component C being reflected from the surface, when the light refracts on and transmits through the prism sheet 41. Among these light components, the component A exits in the direction of the front surface, that is, in the direction of observation, and is an actually used light. The reflected component C is diffused in and reflected from the bottom surface to change the angle of light incident on the prism sheet, and a part of the component C is converted into the component A to exit in the direction of the front surface. By repeating the reflection, most of the component C is converted into the component A to increase the luminance intensity in the direction of the front surface of the exit surface.

In contrast, the light component B passing through the X portion of FIG. 6 is a light (hereinafter, referred to as side lobe light) exiting at a wide angle other than an effective viewing angle of the liquid crystal display device and the like, and does not contribute to the increase in luminance intensity of the front surface.

The side lobe light is incident on the liquid crystal panel at an angle extremely apart from the direction of the normal line of the screen and is frontally scattered by liquid crystal molecules of the liquid crystal cell, the color filter, the phase difference film and the like to significantly increase the luminance intensity of black display, the side lobe light which contributes to the reduction in contrast.

The prism sheet preferably used in the liquid crystal display device of the present invention may decrease the side lobe light to prevent the increase in luminance intensity of black display, thereby exhibiting the effect of improving the contrast.

When the amount of light exiting from the backlight unit including the reflection type polarizing plate, the phase difference film, the light collecting sheet and the surface light source is measured, with respect to the normal line of a display screen of the liquid crystal display device, the average value of the amounts of light at an exit angle in the range of from 50° to 85°, which is inclined to the vertical direction or horizontal direction when the liquid crystal display screen is visually recognized by an observer, is preferably 12% or less, more preferably 8% or less and most preferably 4% or less from the viewpoint of the contrast based on the amount of light in the direction of the normal line.

In particular, when the liquid crystal display device of the present invention uses a TN mode liquid crystal cell, a display screen of the TN mode liquid crystal cell, when viewed from the side of a visually recognizing person, is disposed such that the long side of a wide screen is typically used as a horizontal direction to twist the alignment direction of liquid crystal molecules in the liquid crystal cell from 45° to 135°, and thus, the direction in which the in-plane phase difference of the TN mode liquid crystal cell is a maximum becomes the vertical direction. However, a liquid crystal display device disposed opposite to the configuration may be used according to the use thereof.

In particular, when the liquid crystal display device of the present invention uses a TN mode liquid crystal cell, the light collecting sheet collects light in a direction from which an in-plane phase difference of the TN mode liquid crystal cell becomes the maximum, and in the case where the side lobe light in the direction is low, a significant effect is exhibited, which is preferred. However, in order to prevent the moire patterns with pixels of the liquid crystal cell, the ridge line of the prism may be inclined in a range of from 1° to 20° with respect to the black matrix of the pixel.

As the unevenness pattern of the cross-section of the prism, a triangular shape is preferred, and particularly, an isosceles triangular shape is more preferred, and a prism sheet having a convex portion facing the liquid crystal cell side is preferred.

As the characteristic of the shape, the apex angle of the triangular shape is preferably from 95° to 130°, and more preferably from 100° to 120°. When the apex angle is less than 95°, the angle is likely to become responsible for the significant increase in luminance intensity of black display by the effect of the side lobe light.

In contrast, when the apex angle is more than 130°, the light collecting effect is decreased, and thus the luminance intensity in the direction of the front surface may be reduced in some cases.

Even when the apex angle of the triangular shape of the cross section of the prism is less than 95°, the side lobe light may be decreased by installing an optical adjusting part on the support separately from a prism part, which is another preferred aspect.

A prism sheet with a plurality of optical adjusting parts disposed at a predetermined interval at an in-plane on the support is also a preferred aspect, and as the optical adjusting part, there are optical adjusting parts having light reflectivity, having light diffusivity and using refractive index difference, and particularly, an optical adjusting part having light reflectivity is preferred.

These optical adjusting parts have the same meaning as the optical adjusting parts of an optical sheet described in Japanese Patent Application Laid-Open Nos. 2008-003515 and 2008-176197.

### —Manufacturing Method of Prism Sheet—

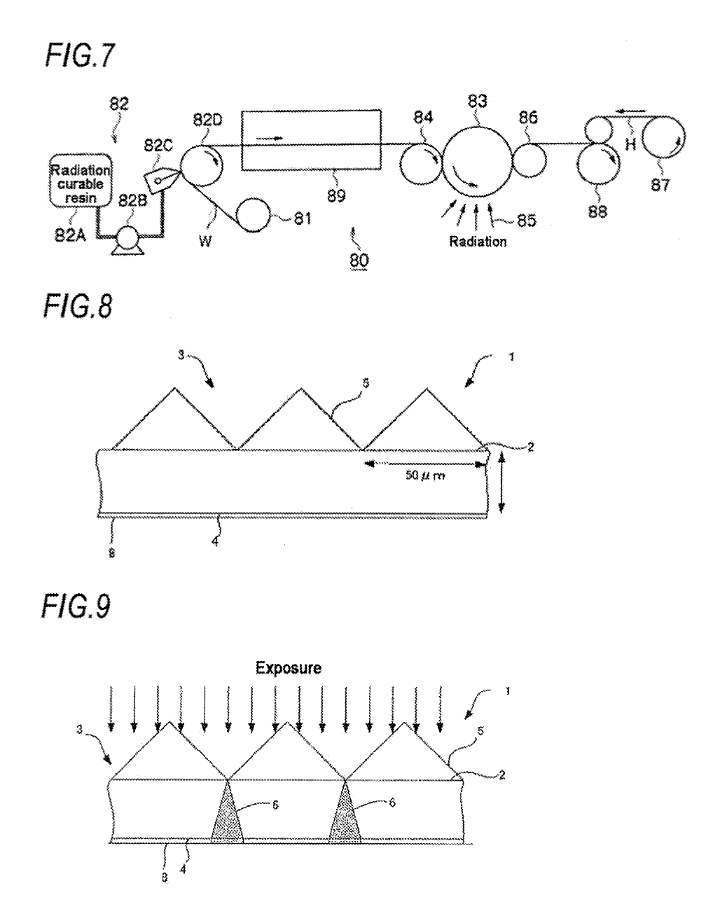

An exemplary example of the manufacturing method of a prism sheet will be described in reference to FIG. 7. FIG. 7 is a schematic view illustrating an example of an apparatus for manufacturing a prism sheet. The apparatus for manufacturing a prism sheet 80 include an unit for supplying a sheet 81, a coating unit 82, a drying unit 89, an embossing roll with unevenness 83, a nip roll 84, a resin curing unit 85, a peeling roll 86, an unit for supplying a protective film 87, an unit for winding a sheet 88, and so on.

The detail of the manufacturing method of a prism sheet is the same as described in Japanese Patent Application Laid-Open No. 2008-176197.

[Phase Difference Film]

In the present invention, a phase difference film having a λ/4 function is used. The phase difference film may be a single layer structure or a laminated structure. If the phase difference film includes a polymer film, the phase difference film may also be used as a protective film of a polarization film disposed adjacent to each other, which is preferred. Examples of a member having a λ/4 function include a phase difference polymer film, a laminated body of phase difference films, an optical anisotropic layer formed by fixing the alignment of a liquid crystal compound, and a laminated body of the optical anisotropic layer and a polymer film supporting the same, and any one thereof may be used. Examples of the phase difference polymer film include a film having an optical anisotropy exhibited by stretching the polymer film to arrange polymers in the film. The film may be configured by one sheet or two sheets or more of biaxial films, and may also be configured by a combination of two or more sheets of uniaxial films such as a combination of the C plate and the A plate. Of course, the film may also be configured by a combination of one or more sheets of biaxial films and one or more sheets of uniaxial films. The optical anisotropic layer is a layer showing an optical anisotropy exhibited by the alignment of molecules of a liquid crystalline compound. The optical anisotropic layer may have a λ/4 function alone, and the optical anisotropic layer in combination with a polymer film which becomes a support may have a λ/4 function as a whole.

The in-plane retardation Re (550) of the phase difference film is preferably from 100 nm to 175 nm, more preferably from 110 nm to 165 nm, and even more preferably from 115 nm to 155 nm.

The retardation Rth (550) in the thickness direction of the phase difference film is preferably from −400 nm to 260 nm, more preferably from −200 nm to 160 nm, even more preferably from −90 nm to 90 nm and most preferably from −20 nm to 20 m. By setting the value in the ranges, a phase difference film having a λ/4 function, in which light has a small dependence on wavelength or a small dependence on incidence angle, may be obtained. Ideally, it is preferred that Re becomes λ/4 in wavelength dispersion at any of 450 nm, 550 nm and 630 nm. That is, an ideal phase difference film satisfies the requirement that Re (450)=112.5 nm, Re (550)=137.5 nm and Re (630)=157.5 nm. Ideally, it is preferred that Rth of the phase difference film becomes 0 nm at any wavelength. That is, the film ideally satisfies the requirement that Rth (450)=0 nm, Rth (550)=0 nm and Rth (630)=0 nm.

The wavelength dispersion in Re throughout the phase difference film is 0.80≦Re (450)/Re (550)≦1.21, and preferably 0.82≦Re (630)/Re (550)≦1.11, and is (IV) 1.00≦Re (450)/Re (550)≦1.18 and more preferably (V) 0.92≦Re (630)/Re (550)≦1.00.

It is preferred that the phase difference film has a moisture vapor permeability of 100 g/m²/day or less at 40° C. and 90% RH.

When the moisture vapor permeability exceeds 100 g/m²/day at 40° C. and 90% RH, the permeability is not preferred because the durable non-uniformity may not be improved. From the viewpoint, the moisture vapor permeability is preferably from 5 g/m²/day to 100 g/m²/day and more preferably from 15 g/m²/day to 80 g/m²/day. When the moisture vapor permeability is too low, in the case where a slight durable non-uniformity occurs, it may take some time for the durable non-uniformity to disappear in some cases.

A preferred phase difference film used in the present invention is not particularly limited as long as the film has a moisture vapor permeability of 100 g/m²/day or less at 40° C. and 90% RH, but is preferably a cyclic olefin-based polymer film containing a cyclic olefin-based resin as a main component.

Examples of the cyclic olefin-based resin include (1) norbornene-based polymers (2) polymers of single-ring cyclic olefins, (3) polymers of cyclic conjugated dienes, 4) vinyl alicyclic hydrocarbon polymers, hydrides of (1) to (4) and the like. A preferred polymer used in the phase difference film of the present invention is a norbornene-based (co)polymer.

Specific examples of the norbornene-based (co)polymers include ring-opening polymers of norbornene-based monomers, ring opening copolymers of norbornene-based monomers with another ring opening polymerizable monomers, hydrogen adduts thereof, addition polymers of norbornene-based monomers, addition copolymers of norbornene-based monomers with other addition polymerizable monomers, and the like. Among them, addition (co)polymers of norbornene-based monomers and ring opening (co)polymer hydrogen adducts are most preferred from the viewpoint of transparency or moisture vapor permeability.

Norbornene-based addition (co)polymers are disclosed in Japanese patent Application Laid-Open No. 10-7732, Japanese Patent Publication No. 2002-504184, US Patent Application Publication No. 2004/229157, International Publication No. WO2004/070463 and the like. The norbornene-based addition (co)polymer is obtained by addition polymerizing norbornene-based polycyclic unsaturated compounds with each other. If necessary, a norbornene-based polycyclic unsaturated compound may be addition-polymerized with ethylene, propylene and butene; a conjugated diene such as butadiene and isoprene; a non-conjugated diene such as ethylidene norbornene; or a linear diene compound such as acrylonitrile, acrylic acid, methacrylic acid, maleic anhydride, acrylic acid ester, methacrylic acid ester, maleimide, vinyl acetate and vinyl chloride. The norbornene-based addition (co)polymers are commercially available under the trade name of APL from Mitsubishi Chemical Inc., including grades different in the glass transition temperatures (Tg), such as APL8008T (Tg 70° C.), APL6013T (Tg 125° C.) or APL6015T (Tg 135° C.). A pellet such as TOPAS8007 (Tg 80° C.), TOPAS6013 (Tg 140° C.) and TOPAS6015 (Tg 160° C.) is commercially available from Polyplastics Co., Ltd. Appear 3000 (Tg 330° C.) is commercially available from Ferrania Company.

As disclosed in Japanese Patent Application Laid-Open Nos. 1-240517, 7-196736, 60-26024, 62-19801, 2003-159767, 2004-309979 or the like, the norbornene-based ring opening polymer hydride is prepared by subjecting a polycyclic unsaturated compound to addition polymerization or metathesis ring-opening polymerization and then to hydrogenation. As for these norbornene-based resins, a product under the trade name of Arton G or Arton F from JSR Corp. is commercially available and products under the trade name of Zeonor 750R, Zeonor 1020 R and Zeonor 1600, and Zeonex 250 or Zeonex 280 from ZEON Corporation are commercially available, and thus, these products may be used.

In the phase difference film, various additives (for example, anti-degradation agent, ultraviolet ray inhibitor, fine particle, peeling accelerator, infrared absorbent and the like) may be added depending on usage at each preparation process. These additives may be a solid or an oil. That is, the melting point or boiling point thereof is not particularly limited. For example, ultraviolet ray absorbing materials having a melting point of 20° C. or less and a melting point of 20° C. or more may be mixed, and anti-degradation agents may be mixed in the same manner. Infrared absorbing dyes are described in, for example, Japanese Patent Application Laid-Open No. 2001-194522. As for the timing of addition, the additive may be added at any step in the process of producing a cyclic polyolefin-based resin solution (dope), but a process of adding the additive to prepare a dope may be further included in the final preparation step in the process of preparing the dope. The amount of each material added is not particularly limited as long as functions thereof are exhibited. In the case of forming a multilayered cyclic polyolefin-based resin film, the kind or amount of the additive added may differ among each layer.

Materials for the phase difference polymer film or the polymer film used as the support of the optical anisotropic layer are not particularly limited. Examples thereof include various films such as cellulose acylate (for example, cellulose triacetate films, cellulose diacetate films, cellulose acetate butylate films and cellulose acetate propionate films), polycarbonate-based polymers, polyester-based polymers such as polyethylene terephthalate and polyethylene naphthalate, acrylic polymers such as polymethylmethacrylate, styrene-based polymers such as polystyrene and acrylonitrile-styrene copolymer (AS resin), polyolefins such as polyethylene and polypropylene, cyclic olefin-based polymers such as norbornene, polyolefin-based polymers such as ethylene-propylene copolymer, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, chloride vinylidene-based polymers, vinyl alcohol-based polymers, vinyl butyral-based polymers, arylate-based polymers, polyoxymethylene-based polymers, epoxy-based polymers, polymer mixtures of the above polymers, and the like. One or two or more polymers may be used as a main component. Commercially available products may be used, and Arton (manufactured by JSR Corp.) which is a cyclic olefin-based polymer, Zeonex (manufactured by Zeon Corporation) which is an amorphous polyolefin and the like may be used. Among them, triacetyl cellulose, polyethylene terephthalate and cyclic olefin-based polymers are preferred, and triacetyl cellulose is particularly preferred.

A method for preparing the phase difference polymer film is not particularly limited. Either a solution film forming method or a melt film forming method may be used. In order to obtain a desired characteristic, a film may be subjected to stretching treatment after formation of the film. When an optical anisotropic layer including a liquid crystal composition is formed thereon, the polymer film may be subjected to surface treatment (for example, a glow discharge treatment, a corona discharge treatment, an ultraviolet ray (UV) treatment, a flame treatment and a saponification treatment) and the like.

The thickness of the phase difference polymer film is not particularly limited, but a film having a thickness of from 25 μm to 1,000 μm is typically used.

A polymer film used as a support of an optical anisotropic layer including a liquid crystal composition to be described below may have a low Re, and a value of, for example, from 0 nm to 50 nm, from 0 nm to 30 nm, or from 0 nm to 10 nm is suitable. The Rth of the polymer film used as a support is not particularly limited, and a value of, for example, from −300 nm to 300 nm, from −100 nm to 200 nm, or from −60 nm to 60 nm is suitable. It is preferred that optical characteristics of the support are selected by a combination with an optical anisotropic layer formed thereon.

The phase difference film may have one or more of an optical anisotropic layer including a composition containing a liquid crystal compound. The kind of liquid crystalline compound is not particularly limited. For example, it also is possible to use an optical anisotropic layer obtained by forming a low molecular weight liquid crystalline compound in a nematic alignment in a liquid crystal state and then fixing the alignment by means of photocrosslinking or thermal crosslinking, or an optical anisotropic layer obtained by forming a polymer liquid crystalline compound in a nematic alignment in a liquid crystal state and then cooling the polymer to fix the alignment. In the present invention, even when a liquid crystalline compound is used in an optical anisotropic layer, the optical anisotropic layer is a layer formed by fixation by polymerization and the like of the liquid crystalline compound, and it is not necessary to show liquid crystallinity after the film is formed into a layered form. A polymerizable liquid crystalline compound may be a polyfunctional polymerizable liquid crystal compound or a monofunctional polymerizable liquid crystalline compound. The liquid crystalline compound may be a discotic liquid crystalline compound or a rod-like liquid crystalline compound.

In the optical anisotropic layer, it is preferred that molecules of the liquid crystal compound are fixed in an alignment state of a vertical alignment, a horizontal alignment, a hybrid alignment and an inclined alignment. One example is that a disc surface of the discotic liquid crystalline compound is aligned substantially vertically to a film surface (surface of the optical anisotropic layer), and another example is that the major axis of a rod-like liquid crystalline compound is aligned substantially horizontally to a film surface (surface of the optical anisotropic layer). The fact that the discostic liquid crystalline compound is substantially vertical means that an angle between the film surface (surface of the optical anisotropic layer) and the disc surface of the discotic liquid crystalline compound has an average value in the range of from 70° to 90°. The average value is preferably from 80° to 90° and more preferably from 85° to 90°. The fact that the rod-like liquid crystalline compound is substantially horizontal means that an angle between the film surface (surface of the optical anisotropic layer) and the director of the rod-like liquid crystalline compound is in the range of from 0° to 20°. The value is preferably from 0° to 10°, and more preferably from 0° to 5°.

When an optical anisotropic layer with an asymmetric viewing angle dependence is manufactured by aligning molecules of the liquid crystal compound in a hybrid alignment, the director of the liquid crystal compound has an average inclination angle of preferably from 5° to 85°, more preferably from 10° to 80°, and even more preferably from 15° to 75°.

The optical anisotropic layer may be formed by coating a liquid crystalline compound such as a rod-like liquid crystalline compound or a disc type (discotic) liquid crystalline compound, and if desired, a coating liquid containing a polymerization initiator, an alignment controlling agent or other additives, which will be described below, on a support. It is preferred that an alignment film is formed on the support, and then the optical anisotropic layer is formed by coating the coating liquid on the surface of the alignment film.

[Rod-Like Liquid Crystalline Compound]

A rod-like liquid crystalline compound may be used for forming an optical anisotropic layer which a phase difference film has. The rod-like liquid crystalline compound is preferably azomethines, azoxys, cyanobiphenyls, cyanophenyl esters, benzoic acid esters, phenyl cyclohexanecarboxylate esters, cyanophenylcyclohexanes, cyano-substituted phenylpyrimidines, alkoxy-substituted phenylpyrimidines, phenyl dioxanes, tolans and alkenylcyclohexyl benzonitriles. The above low molecular weight liquid crystalline compound as well as polymer liquid crystalline compounds may be used. It is more preferred that the alignment of the rod-like liquid crystalline compound is fixed by polymerization. As the liquid crystalline compound, compounds having a partial structure capable of causing a polymerization or crosslinking reaction by activated light rays, electronic rays, heat and the like are suitably used. The number of the partial structures is preferably from 1 to 6 and more preferably from 1 to 3. As a polymerizable rod-like liquid crystalline compound, compounds described in Makromol. Chem., vol. 190, page 2255 (1989), Advanced Materials vol. 5, page 107 (1993), U.S. Pat. Nos. 4,683,327, 5,622,648 and 5,770,107, International Publication Nos. WO95/22586, 95/24455, 97/00600, 98/23580 and 98/52905, Japanese Patent Application Laid-Open Nos. 1-272551, 6-16616, 7-110469 and 11-80081, Japanese Patent Application Laid-Open No. 2001-328973 and the like may be used.

[Discotic Liquid Crystalline Compound]

In the present invention, it is preferred that a discotic liquid crystalline compound is used for forming the optical anisotropic layer that the phase difference film has. The discotic liquid crystalline compound is described in various literatures (C. Destrade et al., Mol. Cryst. Liq. Cryst., vol. 71, page 111 (1981); Quarterly Survey of Chemistry, No. 22, Chemistry of Liquid Crystal, Chap. 5, Chap. 10 Section 2 (1994) published by Chemical Society of Japan; B. Kohne et al., Angew. Chem. Soc. Chem. Comm., page 1794 (1985); and J. Zhang et al., J. Am. Chem. Soc., vol. 116, page 2, 655 (1994)). The polymerization of discotic liquid crystalline compounds is described in Japanese Patent Application Laid-Open No. 8-27284.

It is preferred that the discotic liquid crystalline compound has a polymerizable group to allow the compound to be fixed by polymerization. For example, a structure is contemplated, in which a polymerizable group as a substituent is bonded to the disc type core of the discotic liquid crystalline compound. However, when the polymerizable group is directly bonded to the disc type core, it is difficult to maintain the alignment state in the polymerization reaction. Thus, a structure having a linking group between the discotic core and the polymerizable group is preferred. That is, the discotic liquid crystalline compound having a polymerizable group is preferably a compound represented by the following formula.

D(-L-P)ₙ

In the formula, D is a disc type core, L is a divalent linking group, P is a polymerizable group, and n is an integer of from 1 to 12. Preferably specific examples of the disc type core D, the divalent linking group L and the polymerizable group P in the formula are (D1) to (D15), (L1) to (L25) and (P1) to (P18), respectively, described in Japanese Patent Application Laid-Open No. 2001-4837, and the contents described in the same official gazette may be preferably used. Meanwhile, the discotic nematic liquid crystalline phase-solid phase transition temperature of the liquid crystalline compound is preferably from 30° C. to 300° C., and more preferably from 30° C. to 170° C.

A discotic liquid crystalline compound represented by the following Formula (I) has a low wavelength dispersibility of the in-plane retardation, and thus, a high in-plane retardation may be exhibited. A vertical alignment having excellent uniformity at a high average inclination angle may be achieved without using a special alignment film or additives, and thus the compound is preferably used for forming an optical anisotropic layer. A coating liquid containing the liquid crystalline compound has a tendency that the viscosity thereof is relatively decreased and thus is preferred even from the viewpoint of excellent coating properties.

(1)-1 Discotic Liquid Crystal Compound Represented by Formula (I)

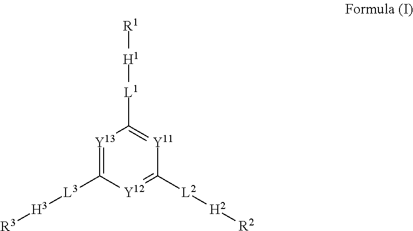

In the formula, each of Y¹¹, Y¹² and Y¹³ independently represents methine or a nitrogen atom which may be substituted; each of L¹, L² and L³ independently represents a single bond or a divalent linking group; each of H¹, H² and H³ independently represents a group of Formula (I-A) or Formula (I-B); and each of R¹, R² and R³ independently represents the following Formula (I-R);

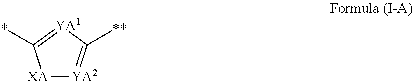

In Formula (I-A), each of YA¹ and YA² independently represents methine or a nitrogen atom; XA represents an oxygen atom, a sulfur atom, methylene or imino; * represents a position of bonding to the side of L¹ to L³ in Formula (I); and ** represents a position of bonding to the side of R¹ to R³ in Formula (I).

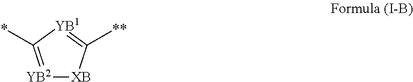

In Formula (I-B), each of YB¹ and YB² independently represents methine or a nitrogen atom; XB represents an oxygen atom, a sulfur atom, methylene or imino; * represents a position of bonding to the side of L¹ to L³ in Formula (I); and ** represents a position of bonding to the side of R¹ to R³ in Formula (I).

*-(-L²-Q²)ₙ₁-L²²-L²³-Q¹ Formula (I—R)

In Formula (I—R), * represents a position of bonding to the side of H¹ to H³ in Formula (I); L²¹ represents a single bond or a divalent linking group; Q² represents a divalent group (cyclic group) having at least one cyclic structure; n1 represents an integer of from 0 to 4; L²² represents **—O—, **—O—OO—, **—CO—O—, **—O—OO—O—, **—S—, **—NH—, **—SO₂—, **—CH₂—, **—CH═CH— or **—C≡—C—; L²³ represents a divalent linking group selected from the group consisting of —O—, —S—, —C(═O)—, —SO₂—, —NH—, —CH₂—, —CH═CH— and —C≡C— and combinations thereof; and Q¹ represents a polymerizable group or a hydrogen atom.

With respect to preferred ranges of each symbol of the tri-substituted benzene-based discotic liquid crystal compound represented by Formula (I) and specific examples of the compound of Formula (I), reference may be made to the description in paragraphs to of Japanese Patent Application Laid-Open No. 2010-244038. However, the discotic liquid crystal compound which may be used in the present invention is not limited to the tri-substituted benzene-based discotic liquid crystal compound of Formula (I).

Examples of the triphenylene compound include compounds described in paragraphs to of Japanese Patent Application Laid-Open No. 2007-108732, but the present invention is not limited thereto.

Together with the tri-substituted benzene or triphenylene compound, at least one of pyridinium compounds represented by the following Formula (II) (more preferably Formula (II′)) and at least one of compounds containing a triazine ring group represented by the following Formula (III) may be included. The amount of the pyridinium compound added is preferably from 0.5 part by mass to 3 parts by mass based on 100 parts by mass of the discotic liquid crystalline compound. The amount of the compound containing a triazine ring group added is preferably from 0.2 part by mass to 0.4 parts by mass based on 100 parts by mass of the discotic liquid crystalline compound.

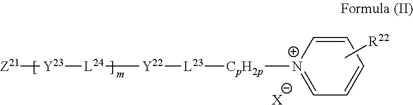

In the formula, each of L²³ and L²⁴ represents a divalent linking group; R²² is a hydrogen atom, an unsubstituted amino group or a substituted amino group having from 1 to 20 carbon atoms; X is an anion; each of Y²² and Y²³ is a divalent linking group having a 5- or 6-membered ring which may be substituted as a partial structure; Z²¹ is a monovalent group selected from the group consisting of halogen-substituted phenyl, nitro-substituted phenyl, cyano-substituted phenyl, phenyl substituted with an alkyl group having from 1 to 10 carbon atoms, phenyl substituted with an alkoxy group having from 2 to 10 carbon atoms, an alkyl group having from 1 to 12 carbon atoms, an alkynyl group having from 2 to 20 carbon atoms, an alkoxy group having from 1 to 12 carbon atoms, an alkoxycarbonyl group having from 2 to 13 carbon atoms, an aryloxycarbonyl group having from 7 to 26 carbon atoms and an arylcarbonyloxy group having from 7 to 26 carbon atoms; p is a number of from 1 to 10; and m is 1 or 2.

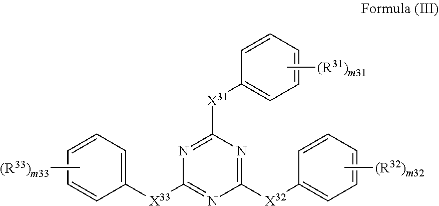

In the formula, R³¹, R³² and R³³ represent an alkyl group or an alkoxy group having a CF₃ group at the end thereof, provided that two or more carbon atoms, which are not adjacent to each other in the alkyl group (also including an alkyl group in the alkoxy group), may be substituted with an oxygen atom or a sulfur atom; X³¹, X³² and X³³ represent a divalent linking group selected from the group consisting of an alkylene group, —CO—, —NH—, —O—, —S—, —SO₂—, and a group combining at least two of them; and each of m31, m32 and m33 is a number of from 1 to 5. In Formula (III), each of R³¹, R³² and R³³ is preferably represented by the following formula.

—O(CₙH₂ₙ)ₙ₁O(CₘH₂ₘ)ₘ₁—CₖF₂ₖ₊₁

In the formula, each of n and m is from 1 to 3, each of n1 and m1 is from 1 to 3, and k is from 1 to 10.

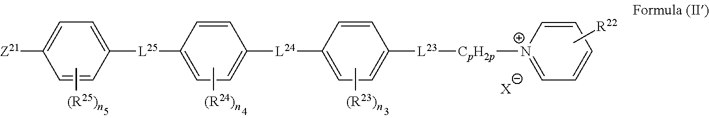

In Formula (II′), the same numerals have the same meanings as the numerals in Formula (II); L²⁵ has the same meaning as L²⁴; and each of R²³, R²⁴ and R²⁵ represents an alkyl group having from 1 to 12 carbon atoms, n3 represents from 0 to 4, n4 represents from 1 to 4, and n5 represents from 0 to 4.

A polymerizable liquid crystalline composition used for forming the optical anisotropic layer may contain at least one kind and may contain one or more additives along with the composition. Examples of available additives will be described with respect to an air-interface alignment controlling agent, a cissing inhibitor, a polymerization initiator, a polymerizable monomer and the like.

Air-Interface Alignment Controlling Agent:

At an air-interface, the composition is aligned at the tilt angle of the air-interface. The degree of the tilt angle varies depending on the type of the liquid crystalline compound, the type of the additives or the like, which are included in the liquid crystalline composition, and thus, it is necessary to optionally control the tilt angle of the air-interface according to the object thereof.

For controlling the tilt angle, for example, an external field such as an electric field or a magnetic field may be used, or an additive may be used, and it is preferred to use an additive. The additive is preferably a compound having one or more substituted or unsubstituted aliphatic groups having from 6 to 40 carbon atoms or one or more substituted or unsubstituted aliphatic-substituted oligosiloxanoxy groups having from 6 to 40 carbon atoms in the molecule thereof, and more preferably a compound having two or more groups in the molecule. For example, as the air-interface alignment controlling agent, hydrophobic excluded volume effect compounds described in Japanese Patent Application Laid-Open No. 2002-20363 may be used.

Fluoroaliphatic group-containing polymers described in Japanese Patent Application Laid-Open No. 2009-193046 and the like have the same actions, and thus, may be added as an air-interface alignment controlling agent.

The amount of an additive added for controlling the alignment at the air-interface side is preferably from 0.001 mass % to 20 mass %, more preferably from 0.01 mass % to 10 mass %, and even more preferably from 0.1 mass % to 5 mass % based on the composition (the solid content in the case of a coating liquid. The rest is the same).

Cissing Inhibitor:

As a material that is added to the composition for the purpose of preventing the cissing of the composition when the composition is coated, in general, a polymer compound may be suitably used.

The polymer to be used is not particularly limited as long as the polymer does not significantly inhibit the tilt angle change or the alignment of the composition.

Examples of the polymer are described in Japanese Patent Application Laid-Open No. 8-95030. Particularly preferred specific examples of the polymer are cellulose esters. Examples of the cellulose ester include cellulose acetate, cellulose acetate propionate, hydroxypropyl cellulose and cellulose acetate butyrate.

In order not to interfere the alignment of the composition, the amount of the polymer used for the purpose of preventing cissing is generally in a range of from 0.1 mass % to 10 mass %, preferably in a range of from 0.1 mass % to 8 mass %, and more preferably from 0.1 mass % to 5 mass %, based on the composition.

Polymerization Initiator:

It is preferred that the composition contains a polymerization initiator. When the composition containing a polymerization initiator is used, an optical anisotropic layer may be prepared by heating the composition at a temperature for liquid-crystal phase formation, polymerizing the composition, and then cooling the composition to fix the alignment state. The polymerization includes thermal polymerization using a thermal polymerization initiator, photopolymerization using a photopolymerization initiator and polymerization by electron beam irradiation. For the purpose of preventing the support from being deformed and denatured by heat, photopolymerization or polymerization by electron beam irradiation is preferred.

Examples of the photopolymerization initiator include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combination of triarylimidazole dimer and p-aminophenyl ketone (described in U.S. Pat. No. 3,549,367), acridine and phenazine compounds (described in Japanese Patent Application Laid-Open No. 60-105667 and U.S. Pat. No. 4,239,850), oxadiazole compounds (described in U.S. Pat. No. 4,212,970) and the like.

The amount of the photopolymerization initiator used is preferably from 0.01 mass % to 20 mass %, and more preferably from 0.5 mass % to 5 mass %, based on the composition.

Polymerizable Monomer:

A polymerizable monomer may be added to the composition. The polymerizable monomer which may be used in the present invention is not particularly limited, as long as the monomer has compatibility with the liquid crystal compound to be used in combination and does not significantly cause the inhibition of the alignment of the liquid crystalline composition. Among them, compounds having a polymerizable active ethylenically unsaturated group, for example, a vinyl group, a vinyloxy group, an acryloyl group, a methacryloyl group and the like are preferably used. The amount of the polymerizable monomer added is generally in a range of from 0.5 mass % to 50 mass %, and preferably from 1 mass % to 30 mass % based on the liquid crystal compound to be used in combination. It is particularly preferred to use a monomer having two or more reactive functional groups because an effect for enhancing the adhesiveness with the alignment film may be expected.

The composition may be prepared as a coating liquid. As a solvent for use in preparing the coating liquid, a general purpose organic solvent is preferably used. Examples of the general purpose organic solvent include amide-based solvents (for example, N,N-dimethylformamide), sulfoxide-based solvents (for example, dimethylsulfoxide), heterocyclic solvents (for example, pyridine), hydrocarbon-based solvents (for example, toluene and hexane), alkyl halide-based solvents (for example, chloroform and dichloromethane), ester-based solvents (for example, methyl acetate and butyl acetate), ketone-based solvents (for example, acetone, methyl ethyl ketone, methyl isobutyl ketone and cyclohexanone) and ether-based solvents (for example, tetrahydrofuran and 1,2-dimethoxyethane). Ester-based solvents and ketone-based solvents are preferred, and ketone-based solvents are particularly preferred. The organic solvent may be used in combination of two or more thereof.

The optical anisotropic layer may be prepared by fixing an alignment state of the composition by maintaining the composition in the alignment state. Hereinafter, an example of the preparation method will be described, but the method is not limited thereto.

First, a composition at least containing a polymerizable liquid crystalline compound is coated on the surface of a support (in the case of having an alignment film, on the surface of the alignment film). If desired, heating or the like is performed to obtain a desired alignment state. Subsequently, polymerization and the like are carried out to fix the state to form an optical anisotropic layer. Examples of an additive which may be added to the composition used in the method include the above-described air-interface alignment controlling agent, cissing inhibitor, polymerization initiator, polymerizable monomer and the like.

The coating may be performed by any known method (for example, a wire bar coating method, an extrusion coating method, a direct gravure coating method, a reverse gravure coating method and a die coating method).

In order to realize a uniformly aligned state, it is preferred that an alignment film is used. It is preferred that the alignment film is formed by subjecting the surface of a polymer film (for example, a polyvinyl alcohol film, an imide film and the like) to rubbing treatment. Examples of an alignment film preferably used in the present invention include an alignment film of an acrylic acid copolymer or a methacrylic acid copolymer described in to of Japanese Patent Application Laid-Open No. 2006-276203. It is preferred to use the alignment film because the fluctuation of the liquid crystal compound may be suppressed and thus improvement in contrast property may be achieved.

Subsequently, polymerization is preferably performed in order to fix the alignment state. It is preferred that polymerization is initiated by means of light irradiation by containing a photopolymerization initiator in the composition. It is preferred that ultraviolet ray is used in the light irradiation. The irradiation energy is preferably from 10 mJ/cm² to 50 J/cm², and more preferably from 50 mJ/cm² to 800 mJ/cm². In order to accelerate the photopolymerization, photo irradiation may be performed under heating conditions. The concentration of ambient oxygen is involved in the polymerization degree, and thus when a desired polymerization degree is not reached in air, it is preferred that the oxygen concentration is decreased by a method such as nitrogen substitution. A preferred oxygen concentration is preferably 10% or less, more preferably 7% or less, and even more preferably 3% or less.

A state in which the alignment state is fixed in the present invention is most typically a state in which the alignment is maintained, and is a preferred aspect. However, the state is not limited thereto, and specifically, refers to a state in which there is no fluidity in the fixed composition normally at 0° C. to 50° C., and at a temperature range of from −30° C. to 70° C. under more rigorous conditions, and the fixed alignment form may be stably and continuously maintained without causing any change in the alignment form by means of an external field or an external force. Meanwhile, when the alignment state is finally fixed to form an optical anisotropic layer, the composition need not exhibit the liquid crystallinity any more. For example, polymerization or crosslinking reaction resultantly proceeds by reaction caused by heat, light and the like to obtain a polymerized state, and thus, the liquid crystalline compound may lose liquid crystallinity.

The thickness of the optical anisotropic layer is not particularly limited, but, in general, the thickness is preferably approximately 0.1 μm to 10 μm, and more preferably approximately 0.5 μM to 5 μm.

An alignment film may be used for forming the optical anisotropic layer. As the alignment film, it is possible to use a film obtained by subjecting the surface of a film containing polyvinyl alcohol or modified polyvinyl alcohol as a main component to rubbing treatment, and the like.

Meanwhile, it is preferred that the phase difference film and optical anisotropic layer used in the present invention are continuously prepared in a long-length state. Maintaining the state in which the slow axis is not parallel nor perpendicular to the longitudinal direction is preferred because a polarization film and the slow axis thereof may be bonded to the absorption axis of the polarization film at 45° or 1.35° by a roll-to-roll type. That is, an angle between the slow axis of the phase difference film and the optical anisotropic layer, and the long side is preferably from 5° to 85°.

The angle of the slow axis of the optical anisotropic layer formed of a liquid crystal composition may be adjusted by the angle of rubbing. In the slow axis of the stretched film, the angle of the slow axis may be adjusted by the stretching direction thereof.

[Liquid Crystal Cell]

The liquid crystal cell used in a stereoscopic image display device used in the stereoscopic image display system of the present invention is preferably in a VA mode, an OCB mode; an IPS mode or a TN mode, but is not limited thereto.

In a liquid cell in the TN mode, rod-like liquid crystalline molecules are substantially horizontally aligned when no voltage is applied, and are aligned twisted at from 60° to 120°. Liquid crystal cells in the TN mode are mostly used as a color TFT liquid crystal display device, and are described in various literatures.

In a liquid crystal cell in the VA mode, rod-like liquid crystalline molecules are substantially vertically aligned when no voltage is applied. The liquid crystal cells in the VA mode include (1) liquid crystal cells in the VA mode in a narrow sense in which rod-like liquid crystalline molecules are aligned substantially vertically when no voltage is applied but substantially horizontally when a voltage is applied (described in Japanese Patent Application Laid-Open No. 112-176625), (2) liquid crystal cells in VA mode which is multidomained to expand the viewing angle (MVA mode) (described in SID97, Digest of Tech. Papers (Proceedings) 28 (1997), 845), (3) liquid crystal cells in a mode (n-ASM mode) in which rod-like liquid crystalline molecules are aligned substantially vertically when no voltage is applied but aligned in twisted multidomained mode when a voltage is applied (described in Proceedings of Symposium on Japanese Liquid Crystal Society 58 to 59 (1988) and (4) liquid crystal cells in a SURVIVAL mode (reported in LCD international 98). Any of patterned vertical alignment (PVA) type, optical alignment type and polymer-sustained alignment (PSA) may be used. For details on these modes, reference will be made to detailed descriptions in Japanese Patent Application Laid-Open No. 2006-215326 and Japanese Patent Publication No. 2008-538819.

In a liquid cell in the IPS mode, rod-like liquid crystal molecules are aligned substantially parallel to a substrate, and thus liquid crystal molecules respond planarly as an electric field in parallel to the surface of the substrate is applied. An IPS mode displays black when no electric field is applied thereto, and the transmission axes of a pair of upper and lower polarizing plates are disposed perpendicular to each other. Methods for reducing light leakage in oblique direction during black display using an optically compensatory sheet to enhance viewing angle are disclosed in Japanese Patent Application Laid-Open Nos. 10-54982, 11-202323, 9-292522, 11-133408, 11-305217, 10-307291 and the like.

In a liquid crystal cell in the above-described various modes, an optically compensatory film for optical compensation may be used between a polarization film and the liquid crystal cell for the purpose of compensating for a viewing angle or tint.

In the present invention, there is an aspect in which an optically compensatory film is used in a liquid cell in TN mode exhibits a significant effect, which is preferred.

### <<Optically Compensatory Film for Optically Compensating for Liquid Crystal Cell>>

<Polymer Material for Forming Film>

Polymer materials for forming an optically compensatory film for optically compensating for a liquid crystal cell are not particularly limited, but, for example, it is possible to use cellulose ester, polycarbonate-based polymers, polyester-based polymers such as polyethylene terephthalate and polyethylene naphthalate, acrylic polymers such as polymethyl methacrylate, styrene-based polymers such as polystyrene and acrylonitrile-styrene copolymer (AS resin), and the like. One or two or more polymers are selected from polyolefins such as polyethylene and polypropylene, cyclopolyolefins such as norbornene, and polyolefin-based polymers such as ethylene-propylene copolymer, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, chloride vinylidene-based polymers, vinyl alcohol-based polymers, vinyl butyral-based polymers, arylate-based polymers, polyoxymethylene-based polymers, epoxy-based polymers, polymer mixtures of the above polymers and the like, the polymers are used as main components to prepare a polymer film, and thus the polymer film may be used. A general purpose commercially available polymer film may also be used.

Among them, it is preferred that cellulose ester is used, and from the viewpoint of suitability for processing a polarizing plate, optical expression property, transparency, mechanical characteristics, durability, costs and the like, it is particularly preferred that cellulose acylate having an acyl group such as an acetyl group is used.

<Cellulose Acylate>

When cellulose acylate is used as a material for the optically compensatory film, the optically compensatory film contains one or two or more cellulose acrylates as main components. Herein, “containing as main components” refers to the cellulose acylate when only one cellulose acylate used as a material for a film is used, and refers to cellulose acylate which is contained in the highest ratio when a plurality of cellulose acylates are used.

In cellulose, free hydroxyl groups are present at 2-, 3- and 6-positions per β-1,4 binding-glucose unit. Cellulose acylate is not particularly limited, but it is preferred that cellulose acetate or cellulose acylate having an acyl group other than an acetyl group is used.

Among these three hydroxyl groups, hydrogen atoms of hydroxyl groups of from 2.00 to 2.80 on average are substituted with an acyl group. In a preferred first aspect, all of the substituents are an acetyl group.

In a preferred second aspect, cellulose acetate•propionate, cellulose acetate•butyrate or cellulose acetate•propionate•butyrate is used, in which among three hydroxyl groups, hydrogen atoms of hydroxyl groups of from 2.00 to 2.80 on average are substituted with an acyl group and hydrogen atoms of hydroxyl groups of from 0.50 to 1.50 are substituted with a propionyl group and/or a butyryl group.

In the preferred second aspect, it is particularly preferred that cellulose acetate•propionate is used.

When the total degree of substitution of the acyl group is less than 2.00, unsubstituted hydroxyl groups are present in large amounts, and thus, the dependence of the film on humidity is increased. Thus, the film is not suitable for the use requiring durability to humidity such as the use as an optical member in a liquid crystal display device and the like. In contrast, when the total degree of substitution of the acyl group exceeds 2.80, expression properties of Re and Rth are decreased, which is not preferred. From the viewpoint of both cases, in both the preferred first and second aspects, the total degree of substitution of the acyl group is preferably from 2.20 to 2.70, and more preferably from 2.40 to 2.60.

In the case of the preparation by a three layer co-casting method, it is preferred that the total degree of substitution of the acyl group of cellulose acylate in a core layer is within the range, and the total degree of substitution of the acyl group of cellulose acylate in a layer (hereinafter, referred to as skin layer) disposed outward from the core layer is preferably more than 2.70 and 3.00 or less, and particularly preferably from 2.75 to 2.90.

Meanwhile, in the preferred second aspect, the degree of substitution of the propionyl group and/or the butyryl group of cellulose acylate has an influence on expression properties of Re and Rth of the film and simultaneously on the dependence of the film on humidity and the elastic modulus thereof. By adjusting the degree of substitution of the propionyl group and/or the butyryl group to from 0.5 to 1.5, preferred characteristics may be obtained due to the presence of the compatible groups. The degree of substitution of the propionyl group and/or the butyryl group is preferably from 0.60 to 1.10, and more preferably from 0.80 to 1.00.

Meanwhile, in the present specification, the degree of substitution of the acyl group in cellulose acylate may be calculated by measuring the amount of fatty acid binding per mass of a constitutional unit of cellulose. The measurement method is performed in accordance with “ASTM D817-91”.

Examples of the cellulose as a cellulose acylate raw material include cotton linter, wood pulp (broad leaf pulp, and needle leaf pulp) and the like, and a cellulose acylate obtained from any raw material cellulose may be used. In some cases, mixtures of such cellulose acylate may be also used. Detailed descriptions on these raw material celluloses may be found in, for example, “Lecture on Plastic Materials (17) Cellulose Resins” (written by Maruzawa, Uda, The NIKKAN KOGYO SHIMBUN, Ltd., published in 1970) or Japan Institute of Invention and Innovation, Open Technical Report No. 2001-1745 (pages 7 to 8), and the cellulose acylate film is not particularly limited.

The cellulose acylate has a mass average polymerization degree of preferably from 350 to 800, and more preferably from 370 to 600. The cellulose acylate used in the present invention has a number average molecular weight of preferably from 60,000 to 230,000, more preferably from 70,000 to 230,000 and even more preferably from 78,000 to 120,000.

The cellulose acylate may be synthesized by using an acid anhydride or an acid chloride as an acylating agent. The most industrially common synthesizing methods are as follows. A desired cellulose acylate may be synthesized by esterification of cellulose obtained from cotton linter, wood pulp or the like with a mixed organic acid component including an organic acid (acetic acid, propionic acid and butyric acid) corresponding to an acetyl group, a propionyl group and/or a butyryl group or an acid anhydride thereof (acetic anhydride, propionic anhydride and butyric anhydride).

<Plasticizer>

The optically compensatory film may contain a plasticizer. A plasticizer having good compatibility with a main component (for example, cellulose acylate) of the optically compensatory film has little bleed-out and a low haze value, and reduces the moisture content and the moisture vapor permeability, and thus, is effective in obtaining a high-quality film having high durability.

Plasticizers which may be used in the optically compensatory film are not particularly limited, but examples thereof include phosphoric acid ester-based plasticizers, phthalic acid ester-based plasticizers, polyhydric alcohol ester-based plasticizers, polyhydric carboxylic acid ester-based plasticizers, glycolate-based plasticizers, citric acid ester-based plasticizers, fatty acid ester-based plasticizers, carboxylic acid ester-based plasticizers, polyester oligomer-based plasticizers, sugar ester-based plasticizers, ethylenically unsaturated monomer copolymer-based plasticizers, and the like.

The plasticizers are preferably phosphoric acid ester-based plasticizers, phthalic acid ester-based compounds, polyhydric alcohol ester-based plasticizers, polyester oligomer-based plasticizers, sugar ester-based plasticizers, and ethylenically unsaturated monomer copolymer-based plasticizers, more preferably polyhydric alcohol-based plasticizers, polyester oligomer-based plasticizers, sugar ester-based plasticizers, and ethylenically unsaturated monomer copolymer-based plasticizers, and even more preferably sugar-ester based plasticizers.

In particular, polyester oligomer-based plasticizers, polyhydric alcohol ester-based plasticizers, sugar ester-based plasticizers and ethylenically unsaturated monomer copolymer-based plasticizers are preferred, because these plasticizers have high compatibility with cellulose acylate, reduced bleed out, and high effects of low haze and low moisture vapor permeability, and it is difficult to decompose the plasticizers and deteriorate or deform films by change in temperature and humidity and passage of time.

In an aspect in which a biaxial film is used as an optically compensatory film, among them, sugar ester-based plasticizers, polyester oligomer-based plasticizers and polyhydric alcohol-based plasticizers are particularly preferred as a plasticizer because the optical expression properties thereof are excellent, and sugar ester-based plasticizers are most preferred because the plasticizers are close to cellulose acylate in structure, and thus a film having a very low haze may be manufactured.

In the present invention, plasticizers may be used either alone or in a mixture of two or more thereof. When two or more plasticizers are mixed and used, the compatibility is improved compared to the case in which only one plasticizer is used, and thus it is highly likely to reduce bleed-out and achieve low haze. This is assumed to be due to the fact that the compatibility of a cellulose acylate film with one plasticizer is improved by the other plasticizer which acts as a compatibilizer.

When plasticizers are used in a mixture of two or more thereof, at least one thereof is preferably a sugar ester-based plasticizer or a polyester oligomer-based plasticizer and more preferably a sugar ester-based plasticizer.

In the optically compensatory film, the content of the plasticizer is preferably from 0.1 mass % to 50 mass %, more preferably from 1 mass % to 30 mass %, even more preferably from 5 mass % to 20 mass % and particularly preferably from 7 mass % to 15 mass %, based on a main component polymer (for example, cellulose acylate).

<Phosphoric Acid Ester-Based Plasticizer>

Phosphoric acid ester-based plasticizers are not particularly limited, but examples thereof include triphenyl phosphate (TPP), tricresyl phosphate (TCP), cresyl diphenyl phosphate, octyl diphenyl phosphate, diphenyl biphenyl phosphate (BDP), trioctyl phosphate, tributyl phosphate, and the like.

<Phthalic Acid Ester-Based Plasticizers>

Phthalic acid ester-based plasticizer are not particularly limited, but examples thereof include diethyl phthalate, dimethoxy ethylphthalate, methylphthalate, dioctyl phthalate, dibutyl phthalate, di-2-ethylhexyl phthalate, butylbenzyl phthalate, dibenzyl phthalate, and the like.

<Glycolate-Based Plasticizer>

Glycolate-based plasticizers are not particularly limited, but alkylphthalylalkyl glycolates may be preferably used.

Examples of the alkylphthalylalkyl glycolates include methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthalylethyl glycolate, propylphthalylbutyl glycolate, butylphthalylpropyl glycolate, methylphthalyloctyl glycolate, ethylphthalyloctyl glycolate, octylphthalylmethyl glycolate, octylphthalylethyl glycolate, and the like.

<Polyhydric Alcohol Ester-Based Plasticizer>

Polyhydric alcohol ester-based plasticizers are plasticizers composed of esters of dihydric or more aliphatic polyhydric alcohols with monocarboxylic acids, and have preferably aromatic rings or cycloalkyl rings in the molecule. The plasticizer is preferably an aliphatic polyhydric alcohol ester which is from dihydric to icosahydric.

Examples of the polyhydric alcohols, which may be preferably used in the present invention, include the following alcohols, but the present invention is not limited thereto.

The examples include adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, and the like.

In particular, triethylene glycol, tetraethylene glycol, dipropylene glycol, tripropylene glycol, sorbitol, trimethylolpropane and xylitol are preferred.

Mono carboxylic acids to be used for the polyhydric alcohol ester are not particularly limited, and well known compounds such as aliphatic monocarboxylic acid, alicyclic monocarboxylic acid and aromatic monocarboxylic acid may be used. The use of alicyclic monocarboxylic acid or aromatic monocarboxylic acid is preferred in that moisture vapor permeability and retention are improved.

Examples of preferred monocarboxylic acids are listed below, but the present invention is not limited thereto.

For aliphatic monocarboxylic acids, straight or branched fatty acids having from 1 to 32 carbon atoms may be preferably used. The number of carbon atoms is more preferably from 1 to 20, and particularly preferably from 1 to 10. Use of an acetic acid is preferred because the compatibility with cellulose ester is improved if the acid is included, and a use of a mixture of acetic acid and other monocarboxylic acids is also preferred.

Examples of preferred aliphatic monocarboxylic acids include saturated fatty acids such as acetic acid, propionic acid, butyric acid, valeric acid, caproic acid, enanthic acid, caprylic acid, pelargonic acid, capric acid, 2-ethyl-hexanoic acid, undecylic acid, lauric acid, tridecylic acid, myristic acid, pentadecylic acid, palmitic acid, heptadecylic acid, stearic acid, nonadecane acid, arachidic acid, behenic acid, lignoceric acid, cerotinic acid, heptacosanoic acid, montanic acid, melissic acid and lacceric acid, as well as unsaturated fatty acids such as undecylenic acid, oleic acid, sorbic acid, linoleic acid, linolenic acid and arachidonic acid.

Examples of preferred alicyclic monocarboxylic acids include cyclopentane carboxylic acid, cyclohexane carboxylic acid, cyclooctane carboxylic acid, or derivatives thereof.

Examples of preferred aromatic monocarboxylic acids include benzoic acid, toluic acid, and the like, all of which have benzene rings of benzoic acid into which 1 to 3 alkoxy groups, such as an alkyl group, a methoxy group or an ethoxy group are introduced, aromatic monocarboxylic acids such as biphenyl carboxylic acid, naphthalene carboxylic acid and tetralincarboxylic acid having 2 or more benzene rings or derivatives thereof. Benzoic acid is particularly preferred.

The molecular weight of the polyhydric alcohol esters is not particularly limited, but is preferably 300 to 1,500, and more preferably 350 to 750. A molecular weight in the range is preferred in that the volatility of the polyalcohol is reduced, while the molecular weight is preferred with respect to moisture vapor permeability, or to compatibility with cellulose ester.

Carboxylic acids used in polyhydric alcohol ester may be used either alone or in a mixture of two or more thereof. OH groups in a polyhydric alcohol may be completely esterified, or some of OH groups may be remained as they are.

Hereinafter, specific compounds of polyhydric alcohol ester will be exemplified.

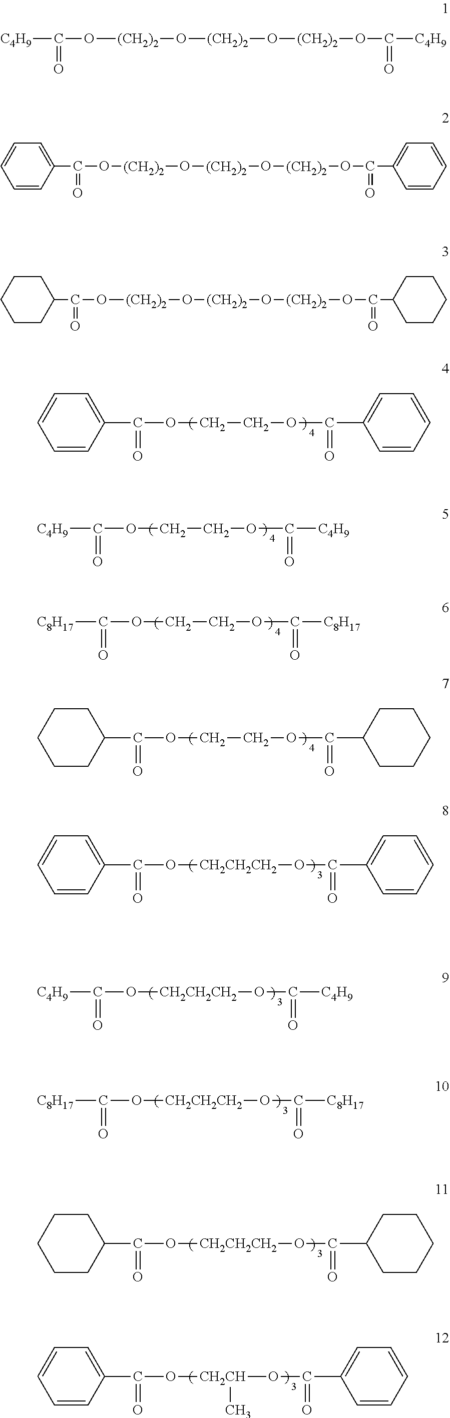

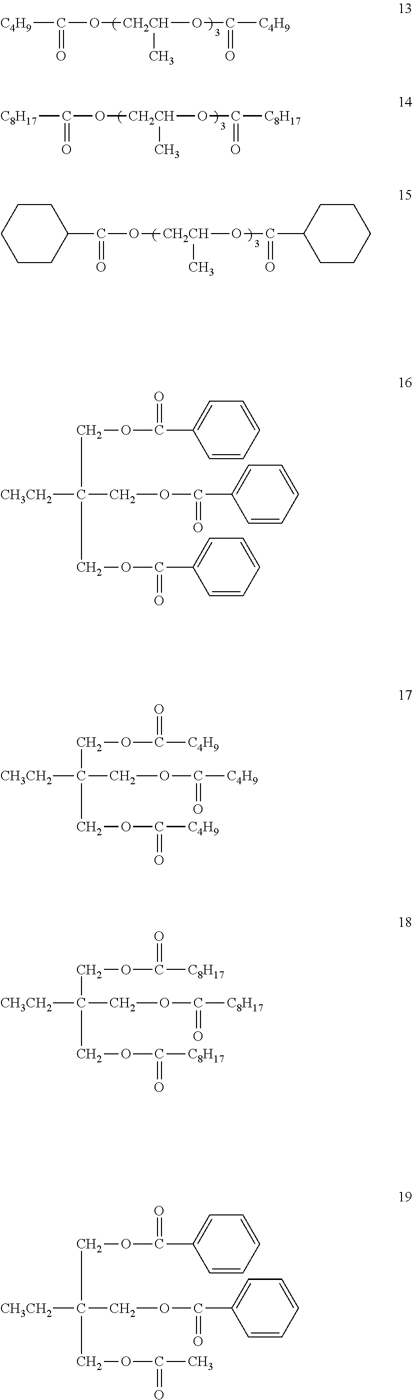

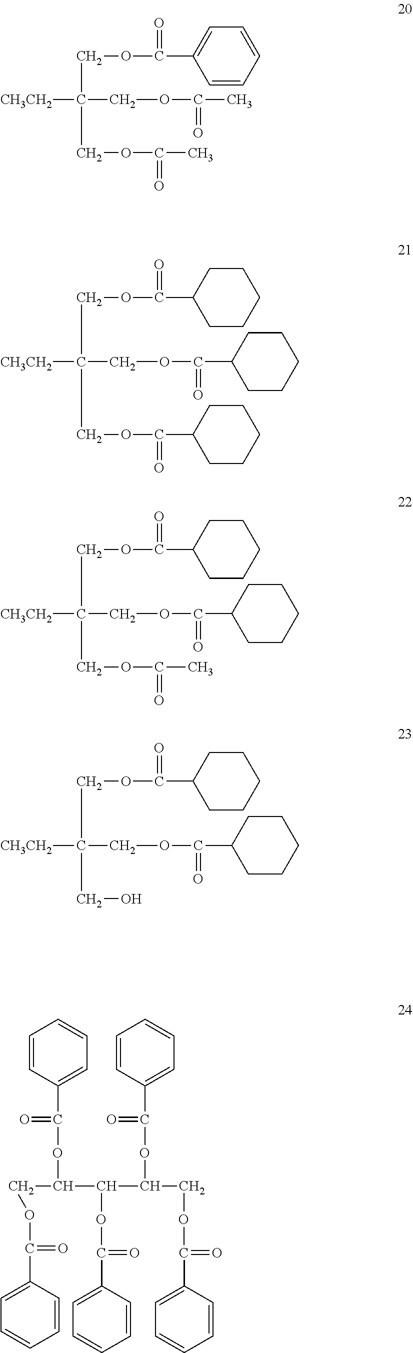

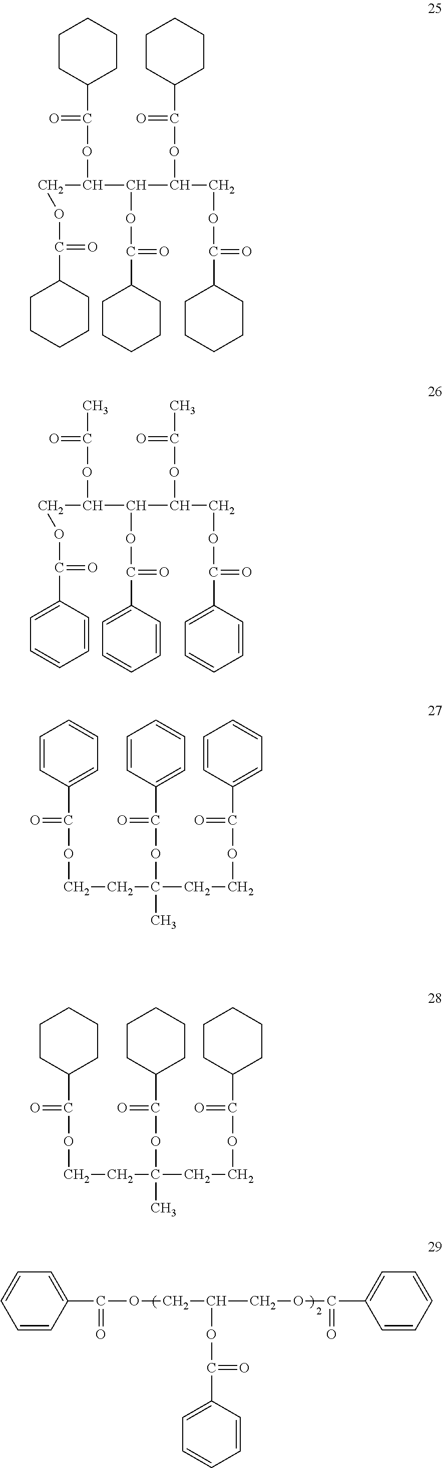

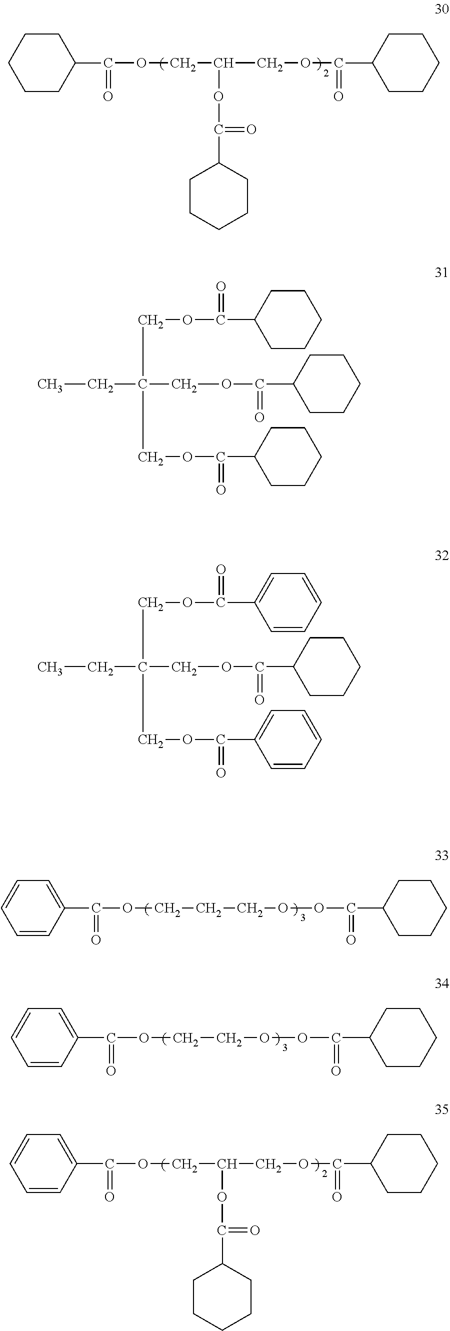

<Polyester Oligomer-Based Plasticizer>

Polyester oligomers in the present invention are a polycondensate obtained by, for example, mixing diol with dicarboxylic acid.

Polyester oligomers preferably have a number average molecular weight of from 300 to 3,000.

The number average molecular weight of the polyester oligomer may be measured by a typical method by means of gel permeation chromatography (GPC).

For example, measurement may be carried out at a temperature of columns (TSKgel Super HZM-H, TSKgel Super HZ4000 and TSKgel Super HZ2000, manufactured by TOSOH CORPORATION) set at 40° C., using THF as an eluent, at a flow rate of 0.35 ml/min, and using a detection with RI, a feed amount of 10 μl, a sample concentration of 1 g/l, and polystyrene as a standard sample.

Examples of dicarboxylic acids may include aromatic dicarboxylic acids and aliphatic dicarboxylic acids. These dicarboxylic acids are included as a dicarboxylic acid residue ester combining with a diol residue in a polyester oligomer.

Aromatic Dicarboxylic Acid Residue:

An aromatic dicarboxylic acid residue is included in a polycondensate obtained from a diol and a dicarboxylic acid including an aromatic dicarboxylic acid.

The aromatic dicarboxylic acid residue refers to a partial structure of a polyester oligomer, and represents a partial structure having the characteristics of the monomers constituting the polyester oligomer. For example, the dicarboxylic acid residue formed from the dicarboxylic acid HOOC—R—COOH is —OC—R—CO—.

The residue ratio of aromatic dicarboxylic acid residues in the entire dicarboxylic acid residues constituting the polyester oligomer used in the present invention is not particularly limited, but is preferably from 40 mol % to 100 mol %.

By setting the ratio of the aromatic dicarboxylic acid residues to 40 mol % or more, a cellulose acylate film exhibiting sufficient optical anisotropy may be obtained.

Examples of the aromatic dicarboxylic acid used in the present invention include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid, 2,6-naphthalene dicarboxylic acid, and the like.

In the polyester oligomer, an aromatic dicarboxylic acid residue is formed by the aromatic dicarboxylic acid which is used for mixing.

The aromatic dicarboxylic acid has an average carbon number of preferably from 8.0 to 12.0, more preferably from 8.0 to 10.0, and even more preferably 8.0. Within this range, the compatibility with cellulose acylate is excellent, and thus it is difficult to generate bleed-out during the film forming of the cellulose acylate film and during heating and stretching, which is thus preferred. The aromatic dicarboxylic acid residue may be used to make a cellulose acylate film capable of sufficiently expressing anisotropy suitable for use in the optically compensatory film in optical applications, which is thus preferred.

Specifically, the aromatic dicarboxylic acid preferably contains at least one of phthalic acid, terephthalic acid, and isophthalic acid, more preferably at least one of phthalic acid and terephthalic acid, and even more preferably terephthalic acid. That is, by using terephthalic acid as an aromatic dicarboxylic acid in mixing in the formation of a polyester oligomer, a cellulose acylate film, in which the compatibility with the cellulose acylate is excellent and it is difficult to generate bleed-out during the film formation of the cellulose acylate film and during heating and stretching, may be made. The aromatic dicarboxylic acids may be used either alone or in a mixture of two or more thereof. When two kinds thereof are used, it is preferred that phthalic acid and terephthalic acid are used.

Aliphatic Dicarboxylic Acid Residue:

An aliphatic dicarboxylic acid residue is included in a polycondensate obtained from diol and a dicarboxylic acid including an aliphatic dicarboxylic acid.

As used herein, the aliphatic dicarboxylic acid residue refers to a partial structure of a polyester oligomer, and represents a partial structure having the characteristics of the monomers constituting the polyester oligomer. For example, the dicarboxylic acid residue formed from the dicarboxylic acid HOOC—R—COOH is —OC—R—CO—.

Examples of the aliphatic dicarboxylic acid which is preferably used in the present invention include oxalic acid, malonic acid, succinic acid, maleic acid, fumaric acid, glutaric acid, adipic acid, pimelic acid, suberic acid, azelaic acid, sebacic acid, dodecane dicarboxylic acid, 1,4-cyclohexane dicarboxylic acid, and the like.

In the polycondensate, an aliphatic dicarboxylic acid residue is formed from the aliphatic dicarboxylic acid used for mixing.

An average carbon number of the aliphatic dicarboxylic acid residue is not particularly limited, but is preferably from 4.0 to 6.0, more preferably from 4.0 to 5.0, and even more preferably from 4.0 to 4.8. Within this range, the compatibility with cellulose acylate is excellent, and thus it is difficult to generate bleed-out during the film formation of the cellulose acylate film and during heating and stretching, which is thus preferred.

Specifically, a succinic acid residue is preferably contained, and when two kinds thereof are used, a succinic acid residue and an adipic acid residue are preferably contained.

That is, at least one or two or more of the aliphatic dicarboxylic acids may be used for the mixing in the formation of a polyester oligomer, and when two kinds thereof are used, succinic acid and adipic acid are preferably used.

By using succinic acid and adipic acid as two kinds of the aliphatic dicarboxylic acids, the average carbon number of the diol residue may be reduced, which is thus preferred from the viewpoint of compatibility with cellulose acylate.

The average carbon number of the aliphatic dicarboxylic acid residue of less than 4.0 makes the synthesis difficult, and thus the residue may not be used.

Diol:

A diol residue is included in a polyester oligomer obtained from diol and dicarboxylic acid.

As used herein, the diol residue refers to a partial structure of a polyester oligomer, and represents a partial structure having the characteristics of the monomers constituting the polyester oligomer. For example, the dicarboxylic acid residue formed from the diol HO—R—OH is —O—R—O—.

Examples of the diol which forms the polyester oligomer include an aromatic diol and an aliphatic diol, and aliphatic diol is preferred even though the diol is not particularly limited.

The diol of the polyester oligomer is not particularly limited, but it is preferred that an aliphatic diol residue having an average carbon number of from 2.0 to 3.0 is included. If the average carbon number of the aliphatic diol residue is more than 3.0, the compatibility with cellulose acylate is low and the bleed-out easily occurs, a loss on heating of the compound increases, and thus it is likely to generate a failure of the surface state which is believed to result from process contamination during drying the cellulose acylate web. The average carbon number of the aliphatic diol residue of less than 2.0 makes the synthesis difficult, and thus the residue may not be used.

Examples of the aliphatic diol include alkyl diols or alicylic diols, for example, ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, diethylene glycol, and the like, and the compounds are preferably used as a mixture of one kind or two or more thereof in combination with ethylene glycol.

Preferred aliphatic diols are at least one of ethylene glycol, 1,2-propanediol and 1,3-propanediol, and particularly preferably at least one of ethylene glycol and 1,2-propanediol. When two kinds thereof are used, it is preferred that ethylene glycol and 1,2-propanediol are used.

In the polyester oligomer, a diol residue is formed by the diol used for mixing.

Capping:

Both terminals of the polyester oligomer may be capped or uncapped, but are more preferably capped.

When both terminals of the polyester oligomer are uncapped, the polycondensate is preferably polyester polyol.

When both terminals of the polyester oligomer are capped, it is preferred that the polyester oligomer is subject to reaction with a monocarboxylic acid to cap the terminals. At this time, both terminals of the polycondensate are composed of monocarboxylic acid residues.

As used herein, the monocarboxylic acid residue refers to a partial structure of a polyester oligomer, and represents a partial structure having the characteristics of the monomers constituting the polyester oligomer. For example, the monocarboxylic acid residue formed from the monocarboxylic acid R—COOH is R—CO—. The capping of the monocarboxylic acid may be performed by using either monocarboxylic acid or aliphatic carboxylic acid. As monocarboxylic acid, for example, acetic acid, propionic acid, butanoic acid, benzoic acid, derivatives thereof and the like are preferred. Two or more of monocarboxylic acids used for capping may be mixed.

The polyester oligomer according to the present invention may be easily synthesized in a typical manner by any one of a hot melt condensation process by a polyesterification reaction or a transesterification reaction between diol and dicarboxylic acid, or an interface condensation process with acid chlorides of these acids and glycols. The polyester oligomer according to the present invention is described in detail in “Plasticizer-Theory and Application” (First Edition, First Impression, published by Saiwai Shobo, Mar. 1, 1973) edited by Kouichi Murai. The materials described in Japanese Patent Application Laid-Open Nos. 05-155809, 05-155810, 05-197073, No. 2006-259494, 07-330670, 2006-342227, 2007-003679 and the like may be used.

The content of aliphatic diol, dicarboxylic acid ester, or diol ester which the polyester oligomer of the present invention contains as raw materials in the cellulose acylate film is preferably less than 1% by mass, and more preferably less than 0.5% by mass. Examples of the dicarboxylic acid ester include dimethyl phthalate, di(hydroxyethyl)phthalate, dimethyl terephtha late, di(hydroxyethyl)terephthalate, di(hydroxyethyl)adipate, di(hydroxyethyl)succinate, and the like. Examples of the diol ester include ethylene diacetate, propylene diacetate, and the like.

An acetic anhydride method as described in Japan Industrial Standard JIS K3342 (abrogated), and so on, may be applied to measurement of the hydroxyl value of the polyester oligomer. When the polyester oligomer is polyester polyol, the hydroxyl value is preferably from 55 to 220, and more preferably from 100 to 140.

Hereinafter, specific examples of polyester oligomer-based plasticizers which may be used in the present invention are shown in Table 1, but the plasticizers are not limited to the following specific examples.

TABLE 1

| | | | Aromatic |
|---|---|---|---|
| Example | | | monocarboxylic |
| of | Aromatic | | acid (Terminal |
| compound | dicarboxylic acid | Aliphatic diol | OH capping agent) |
| E-1 | Terephthalic acid | Ethylene glycol | Benzoic acid |
| E-2 | Terephthalic acid | Ethylene glycol | p-methyl benzoic acid |
| E-3 | Terephthalic acid | 1,2-propanediol | Benzoic acid |
| E-4 | Terephthalic acid | 1,2-propanediol | p-methyl benzoic acid |
| E-5 | 1,4-naphthalenedi- | Ethylene glycol | Benzoic acid |
| | carboxylic acid | | |
| E-6 | 1,4-naphthalenedi- | Ethylene glycol | p-methyl benzoic acid |
| | carboxylic acid | | |
| E-7 | 1,4-naphthalenedi- | 1,2-propanediol | Benzoic acid |
| | carboxylic acid | | |
| E-8 | 1,4-naphthalenedi- | 1,2-propanediol | p-methyl benzoic acid |
| | carboxylic acid | | |
| E-9 | Phthalic acid | 1,2-propanediol | Benzoic acid |
| E-10 | Phthalic acid | 1,2-propanediol | p-methyl benzoic acid |

<Sugar Ester-Based Plasticizer>

Preferred examples of sugar ester-based plasticizers include ester compounds in which at least one hydroxyl group is esterified in a compound having from 1 to 12 furanose structural units or pyranose structural units.

Examples of the ester compounds in which at least one hydroxyl group is esterified in a compound having from 1 to 12 furanose structural units or pyranose structural units may include an esterified compound in which the whole or part of hydroxyl groups are esterified in a compound (compound (A)) having one furanose structural unit or pyranose structural unit; and an esterified compound in which the whole or part of hydroxyl groups are esterified in a compound (compound (B)), in which 2 to 12 of at least one of a furanose structural unit or a pyranose structural unit are bound together.

Hereinafter, an esterified compound of compound (A) and esterified compounds of compound (B) will collectively refer to sugar ester compounds.

It is preferred that the esterified compound is benzoic acid ester of monosaccharide α-glucose, β-fructose) or benzoic acid ester of polysaccharide produced by dehydration condensation of any two or more of —OR⁵¹², —OR⁵¹⁵, —OR⁵²² and —OR⁵²⁵ in monosaccharide represented by the following general formula (5), in which m5+n5=from 2 to 12.

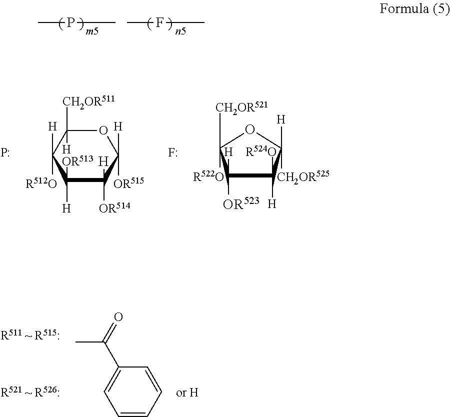

The benzoic acid in the general formula may further have substituent(s), which include(s), for example, an alkyl group, an alkenyl group, an alkoxy group and a phenyl group, and these alkyl group, alkenyl group and phenyl group may have substituent(s).

Preferred examples of compound (A) and compound (B) include the following substances, but the present invention is not limited thereto.

Examples of compound (A) include glucose, galactose, mannose, fructose, xylose, or arabinose.

Examples of compound (B) include lactose, sucrose, nystose, 1F-fructosyl nystose, stachyose, maltitol, lactitol, lactulose, cellobiose, maltose, cellotriose, maltotriose, raffinose or kestose. In addition to them, gentiobiose, gentiotriose, gentiotetraose, xylotriose, galactosylsucrose and the like may be included.

Among these compounds (A) and compounds (B), compounds having both a pyranose structure and a furanose structure are particularly preferred. As an example, sucrose, kestose, nystose, 1F-fructosyl nystose, stachyose and the like are preferred, and sucrose is more preferred. In compound (B), compounds in which 2 to 3 of at least one of a furanose structure or a pyranose structure are bound together are one of preferred aspects.

Monocarboxylic acid used for esterification of the whole or part of hydroxyl groups in compound (A) and compound (B) in the present invention is not particularly limited, and known aliphatic monocarboxylic acid, alicyclic monocarboxylic acid, aromatic monocarboxylic acid and the like may be used. Carboxylic acids used may be used either alone or in a mixture of two or more thereof.

Examples of preferred aliphatic monocarboxylic acids include saturated fatty acids such as acetic acid, propionic acid, butyric acid, isobutyric acid, valerie acid, caproic acid, enanthic acid, caprylic acid, pelargonic acid, capric acid, 2-ethyl-hexane carboxylic acid, undecylic acid, lauric acid, tridecylic acid, myristic acid, pentadecylic acid, palmitic acid, heptadecylic acid, stearic acid, nonadecanoic acid, arachidic acid, behenic acid, lignoceric acid, cerotinic acid, heptacosanoic acid, montanic acid, melissic acid and lacceric acid, as well as unsaturated fatty acids such as undecylenic acid, oleic acid, sorbic acid, linoleic acid, linolenic acid, arachidonic acid and octenoic acid.

Examples of preferred alicyclic monocarboxylic acids include cyclopentane carboxylic acid, cyclohexane carboxylic acid, cyclooctane carboxylic acid, or derivatives thereof.

Examples of preferred aromatic monocarboxylic acids include aromatic monocarboxylic acid in which an alkyl group or an alkoxy group is introduced into a benzene ring of benzoic acid, such as benzoic acid and toluic acid, aromatic monocarboxylic acid having two or more benzene rings such as cinnamic acid, benzilic acid, biphenyl carboxylic acid, naphthalene carboxylic acid and tetralin carboxylic acid, or derivatives thereof, and more specifically, include xylylic acid, hemellitic acid, mesitylenic acid, prehnitylic acid, γ-isodurylic acid, durylic acid, mesitonic acid, α-isodurylic acid, cuminic acid, α-toluic acid, hydratropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid and p-coumaric acid, and benzoic acid is particularly preferred.

Among the esterified compounds in which compound (A) and compound (B) are esterified, acetylated compounds into which acetyl groups are introduced by esterification, benzoylated compounds into which benzoyl groups are introduced, or compounds into which both acetyl groups and benzyl groups are introduced are preferred.

In addition to the esterified compounds of compound (A) and compound (B), esterified compounds of oligosaccharide may be applied as compounds in which 3 to 12 of at least one of a furanose structural unit or a pyranose structural unit are bound together.

Oligosaccharide is prepared by acting an enzyme such as amylase on starch, saccharose and the like, and examples of oligosaccharide which may be applied in the present invention include maltooligosaccharide, isomaltooligosaccharide, fructooligosaccharide, galactooligosaccharide, xylooligosaccharide and the like.

<Additive>

To the optically compensatory film, at least one of additives (for example, retardation controlling agent, wavelength distribution regulator, peeling accelerator, antioxidant, peroxide decomposer, radical inhibitor, metal deactivator, acid scavenger, amine, ultraviolet absorbent, infrared absorbent and the like) other than the plasticizer may be added. The anti-degradation agent is described in Japanese Patent Application Laid-Open Nos. 03-199201, 05-194789, 05-271471, and 06-107854. From the viewpoint of expressing the effect and suppressing the bleed-out (effusion) of an anti-degradation agent to the film surface, for example, in a solution film forming method, the amount of the anti-degradation agent added is preferably from 0.01% by mass to 1% by mass, and more preferably from 0.01% by mass to 0.2% by mass, based on the solution (dope) used in the film formation.

Particularly preferred examples of the anti-degradation agent include butylated hydroxytoluene (BHT) and tribenzylamine (TBA).

<Matting Agent Fine Particle>

To the optically compensatory film, a matting agent may be added. Examples of the fine particle used as a matting agent include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. As the fine particle, a fine particle containing silicon is preferred in that the turbidity is reduced, and silicon dioxide is particularly preferred. The fine particle of the silicon dioxide with a primary average particle size of 20 nm or less and an apparent specific gravity of 70 g/L or more is preferred, because the haze of the film may be reduced. The apparent specific gravity is preferably from 90 g/L to 200 g/L and more preferably from 100 g/L to 200 g/L. A larger apparent specific gravity is preferred because a liquid dispersion with a high concentration may be prepared such that the haze and the coagulated material are excellent.

These fine particles usually form secondary particles with an average particle size of from approximately 0.1 μm to 3.0 μm, and exist as agglomerates of the primary particles in a film and form unevenness of from approximately 0.1 μm to 3.0 μm on the surface of the film. The secondary average particle size is preferably from approximately 0.2 μm to 1.5 μm, more preferably from approximately 0.4 μm to 1.2 and even more preferably from approximately 0.6 μm to 1.1 μm. As for the primary and secondary particle sizes, particles in the film are observed through a scanning electron microscope and the diameter of a circle circumscribing a particle is defined as the particle size. A total of 200 particles at different sites are observed to define the average value thereof as an average particle size.

As the fine particle of the silicon dioxide, a commercially available product such as, for example, AEROSIL R972, R972V, R974, R812, 200, 200V, 300, R202, OX50 and TT600 (all manufactured by Nippon Aerosil Co., Ltd.) may be used. The fine zirconium oxide particle is commercially available under the trade name of, for example, AEROSIL R976 and R811 (both manufactured by Nippon Aerosil Co., Ltd.), and these may be used.

Among them, AEROSIL 200V and AEROSIL R972V, which are fine particles of silicon dioxide having an average primary particle size of 20 nm or less and an apparent specific gravity of 70 g/L or more, are particularly preferred because these particles are highly effective in reducing a frictional coefficient of an optical film while maintaining the turbidity of the film low.

<Preparation Method of Optically Compensatory Film>

A cellulose acylate film used as the optically compensatory film is preferably a film prepared by a solution film forming method (solvent cast method). Hereinafter, as a specific example, a method for preparing a cellulose acylate film will be described, but the optically compensatory film used in the present invention is not limited to the cellulose acylate film.

(Solvent Cast Method)

In the solvent cast method, a dope prepared by dissolving cellulosed acylate in an organic solvent is cast on the surface of a support including a metal and the like and dried to form a film, and thereafter, the film is peeled off from the support surface and, if desired, is subjected to stretching treatment to prepare the film.

In the solvent cast method, a solution (dope) in which cellulose acylate is dissolved in an organic solvent is used to prepare a film. The solvent used in the preparation of the dope may be selected from organic solvents. It is preferred that the organic solvent contains at least a solution selected from ether having from 3 to 12 carbon atoms, ketone having from 3 to 12 carbon atoms, ester having from 3 to 12 carbon atoms, and a halogenated hydrocarbon having 1 to 6 carbon atoms.

The ether, ketone and ester may have a cyclic structure. A compound having two or more of any one of functional groups (that is, —O—, —CO— and COO—) of ether, ketone and ester may also be used as the organic solvent. The organic solvent may have other functional groups, such as an alcoholic hydroxyl group. In the case of an organic solvent having two or more functional groups, it is preferred that the number of carbon atoms thereof is within the above-described preferred range of the number of carbon atoms of the solvent having any one functional group.

Examples of the ethers having from 3 to 12 carbon atoms include diisopropyl ether, dimethoxy methane, dimethoxy ethane, 1,4-dioxane, 1,3-dioxolan, tetrahydrofuran, anisole and phenetole.

Examples of the ketones having from 3 to 12 carbon atoms include acetone, methyl ethyl ketone, diethyl ketone, diisobutyl ketone, cyclohexanone and methylcyclohexanone.

Examples of the esters having from 3 to 12 carbon atoms include ethyl formate, propyl formate, pentyl formate, methyl acetate, ethyl acetate and pentyl acetate.

Examples of the organic solvent having two or more of functional groups include 2-ethoxyethyl acetate, 2-methoxy ethanol and 2-butoxy ethanol.

The number of carbon atoms in a halogenated hydrocarbon is preferably 1 or 2 and most preferably 1. The halogen in the halogenated hydrocarbon is preferably chlorine. The ratio of hydrogen atoms in the halogenated hydrocarbon to be substituted by halogens is preferably from 25 mol % to 75 mol %, more preferably 30 mol % to 70 mol %, even more preferably from 35 mol % to 65 mol % and further even more preferably from 40 mol % to 60 mol %. Methylene chloride is a representative halogenated hydrocarbon.

The organic solvent may be used in a mixture of two or more thereof.

A cellulose acylate film is prepared from the prepared cellulose acylate solution (dope) by a solvent cast method. It is preferred that an additive such as the above-described plasticizers may be added to the dope.

The dope is cast on a drum or a band, and the solvent is evaporated to form a film. It is preferred that the dope before casting is adjusted so as to have a concentration in the range of 18% by mass to 35% by mass in terms of solid content. It is preferred that the surface of the drum or band is mirror-finished. It is preferred that the dope is cast on a drum or a band having a surface temperature of 10° C. or less.

When a dope (cellulose acylate solution) is cast on a band, a substantially airless drying process is performed for 10 sec to 90 sec and preferably from 15 sec to 90 sec in the first half of drying before peeling-off. When a dope is cast on a drum, it is preferred that a substantially airless drying process is performed for 1 sec to 10 sec and preferably from 2 sec to 5 sec in the first half of drying before peeling-off.

As used herein, the term “drying before peeling-off” indicates drying until a dope is coated on a band or drum and then peeled off as a film. The term “first half” indicates a process before a half of the total time required from coating of the dope to peeling off. The term “substantially airless” indicates that an air rate of 0.5 m/sec or more is not detected at a distance within 200 mm from the band surface or drum surface (the air rate is less than 0.5 m/s).

The first half of drying before peeling-off is usually a time period of approximately from 30 sec to 300 sec on the band, but out of this time period, the airless drying is performed for 10 sec to 90 sec and preferably from 15 sec to 90 sec. The first half is usually a time period of approximately from 5 sec to 30 sec on the drum, but out of this time period, the airless drying is performed for from 1 sec to 10 sec and preferably from 2 sec to 5 sec. The ambient temperature is preferably from 0° C. to 180° C. and more preferably from 40° C. to 150° C. The operation of airless drying may be performed at any step in the first half of drying before peeling-off, but is preferably performed immediately after the casting. When the airless drying time is less than 10 sec on the band (less than 1 sec on the drum), it is difficult for the additives to be uniformly distributed in the film, whereas when the airless drying time exceeds 90 sec (exceeds 10 sec on the drum), the film is peeled off due to an insufficient drying state, and thus the surface profile of the film deteriorates.

Drying may be performed by blowing an inert gas for the time period other than the airless drying time in the drying before peeling-off. At this time, the air-blowing temperature is preferably from 0° C. to 180° C. and more preferably from 40° C. to 150° C.

Drying methods in the solvent cast method are described in U.S. Pat. Nos. 2,336,310, 2,367,603, 2,492,078, 2,492,977, 2,492,978, 2,607,704, 2,739,069, and 2739070, GB Pat. Nos. 640731 and 736892, and in of Japanese Patent Publication Nos. 45-4554 and 49-5614 and Japanese Patent Application Laid-Open Nos. 60-176834, 60-203430, and 62-115035. Drying on the band or drum may be performed by blowing an inert gas such as air and nitrogen.

The obtained film is peeled off from the drum or band and further dried by high-temperature air by sequentially varying the temperature from 100° C. to 160° C., whereby the residual solvent may also be evaporated. The above-described method is disclosed in Japanese Patent Publication No. 5-17844. According to this method, it is possible to shorten the time from casting to peeling off. In order to carry out the method, the dope needs to be gelled at the surface temperature of the drum or band during casting.

A film may also be formed using the prepared cellulose acylate solution (dope) by casting the solution in two or more layers. In this case, it is preferred that the cellulose acylate film is prepare by a solvent cast method. The dope is cast on a drum or a band, and the solvent is evaporated to form a film. It is preferred that the dope before casting is adjusted so as to have a concentration in the range of 10% by mass to 40% by mass in terms of solid content. It is preferred that the surface of the drum or band is mirror-finished.

In the case of casting a plurality of cellulose acylate solutions in two or more layers, it is possible to cast a plurality of cellulose acylate solutions, and a film may be prepared by casing and stacking respective cellulose acylate-containing solutions from a plurality of casting nozzles formed at intervals in the support traveling direction. For example, the methods described in Japanese Patent Application Laid-Open No. 61-158414 and Japanese Patent Application Laid-Open Nos. 01-122419 and 11-198285 may be used. A film may also be formed by casting a cellulose acylate solution from two casting nozzles. For example, the methods described in Japanese Patent Publication No. 60-27562 and Japanese Patent Application Laid-Open Nos. 61-94724, 61-947245, 61-104813, 61-158413 and 6-134933 may be used. It is also possible to use a method for casting a cellulose acylate film, including: surrounding the flow of a high-viscosity cellulose acylate solution with a low-viscosity cellulose acylate solution; and simultaneously extruding the high/low viscosity cellulose acylate solutions, which is described in Japanese Patent Application Laid-Open No. 56-162617.

A film may also be prepared using two casting nozzles by peeling off a film formed on a support by means of a first casting nozzle and then performing a second casting on the side that is contacted with the support surface. Examples of this method include the method described in Japanese Patent Publication No. 44-20235.

As for the cellulose acylate solutions cast, the same solution may be used, or different cellulose acylate solutions may be used In order to impart a function to a plurality of cellulose acylate layers, each cellulose acylate solution according to the function may be extruded from each casting nozzle. The cellulose acylate solution of the present invention may be cast simultaneously with other functional layers (for example, an adhesion layer, a dye layer, an antistatic layer, an anti-halation layer, an ultraviolet ray absorbing layer, a polarizing layer and the like).

In the case of a single-layer solution in the related art, a cellulose acylate solution having a high viscosity at a high concentration needs to be extruded in order to obtain a required film thickness. In this case, the cellulose acylate solution has bad stability and often causes generation of a solid material, thereby leading to a problem such as particle defects or planarity defects. As a solution to the problem, by casting a plurality of cellulose acylate solutions from casting nozzles, high-viscosity solutions can be simultaneously extruded on a support, and thus planarity is improved, thereby preparing a film having excellent surface profile. In addition, by using concentrated cellulose ester solutions, a reduction in a drying load may be achieved, and thus the production speed of the film may be enhanced.

In particular, a laminated structure of three layers or more is preferred from the viewpoint of dimension stability or reducing the amount of curling in environmental wet heat change. In particular, when both surfaces of the low substitution layer have the high substitution layer, the constitution is preferred from the viewpoint of improving the degree of freedom in a process of implementing a desired optical characteristic.

In contrast, only in the case of having a laminated structure of three layers or more, the surface layer thereof on the side not in contact with the support during the film formation is referred to as a skin A layer.

In particularly, a three-layer structure of skin B layer/core layer/skin A layer is preferred. A three-layer structure may have a constitution of high substitution layer/low substitution layer/high substitution layer or of low substitution layer/high substitution layer/low substitution layer, but a constitution of high substitution layer/low substitution layer/high substitution layer is preferred from the viewpoint of improving the release property from the support during the solution film formation and from the viewpoint of dimension stability.

In the case of a three-layer structure, it is preferred that the cellulose acylate included in the surface layer on both sides uses a cellulose acylate having the same degree of acyl substitution from the viewpoint of dimension stability and reducing the preparation cost and the amount of curling in environmental wet heat change.

The cellulose acylate film may be prepared to have a width of, for example, from 0.5 m to 5 m, and more preferably from 0.7 m to 3 m. The cellulose acylate film may be prepared to have a winding length of preferably from 300 m to 30,000 m, more preferably from 500 m to 10,000 m, and even more preferably from 1,000 m to 7,000 m.

<Stretching>

As the optically compensatory film, it is possible to use a stretched film with the retardation thereof adjusted by preparing a cellulose acylate film by means of the method and subjecting the cellulose acylate film to further stretching treatment. A method for positively stretching the film in the width direction (a direction perpendicular to the casting direction during the film formation is described in, for example, Japanese Patent Application Laid-Open Nos. 62-115035, 4-152125, 4-284211, 4-298310, 11-48271 and the like. The stretching of the film is performed under normal temperature or heating condition. The heating temperature is preferably from −20° C. to +20° C., including the glass transition temperature of the film therebetween. When the film is stretched at a temperature extremely lower than the glass transition temperature, the film is easily broken into pieces, and thus desired optical characteristics may not be exhibited. When stretching is performed at a temperature extremely higher than the glass transition temperature, a film in which molecules are aligned by stretching is relaxed by heat during the stretching before the alignment is thermally fixed, and thus the alignment may not be fixed, thereby deteriorating the expression of optical characteristics.

In a stretching zone (for example, a tenter zone), after the film is engaged with each other, conveyed and stretched at a maximum width expansion ratio, a zone for relaxing the film is usually provided. This is a zone effective for reducing the axial deviation. In normal stretching, the time that takes for the film to pass through the tenter zone in this relaxation rate zone after stretching at a maximum width expansion ratio is shorter than 1 min, and the stretching of the film may be uniaxial stretching only in the conveying direction or in the width direction or may be simultaneous or sequential biaxial stretching, but it is preferred that stretching is performed predominantly in the width direction. It is preferred that stretching is carried out in the width direction, that is, a direction perpendicular to the casting direction during the film formation, at a magnification of preferably from 1.4 times to twice, more preferably from 1.4 times to 1.6 times, and even more preferably from 1.4 times to 1.5 times.

The stretching treatment may be performed during the film formation process, or a raw fabric obtained by forming a film and winding the film may be subjected to stretching treatment. In the case where stretching is carried out during the film formation process, stretching may also be carried out while including a residual solvent amount, and stretching may be preferably carried out at a residual solvent amount (residual solvent amount)/(residual solvent amount+solid matter amount) of 0.05% to 50%. While the residual solvent amount is maintained at from 0.05% to 5%, stretching is particularly preferably performed at from 5% to 80%.

As the optically compensatory film, a biaxially stretched film in which a cellulose acylate film manufactured by the aforementioned method has been subjected to biaxial stretching treatment may be used.

The biaxial stretching includes a simultaneous biaxial stretching method and a sequential biaxial stretching method, but from the viewpoint of continuous preparation, a sequential biaxial stretching method is preferred. After the dope is cast, the film is peeled off from the band or drum, stretched in a width direction (longitudinal direction) and then stretched in a longitudinal direction (width direction).

The processes from stretching to post-drying may be performed under air atmosphere and may be performed under inert air atmosphere, such as nitrogen gas.

As described above, a film is subjected to stretching treatment in the width direction, that is, a direction perpendicular to the casting direction, and then is preferably prepared through a process of spraying water vapor heated to 100° C. or more. The process is preferred because the residual stress of the cellulose acylate film to be prepared by being subjected to the water vapor spraying process is alleviated and the dimensional change is reduced. The temperature of water vapor is not particularly limited as long as the temperature is 100° C. or more. However, considering the heat resistance of the film, the temperature of water vapor needs to be 200° C. or less.

A cellulose acylate film manufactured in a long shape by the aforementioned method may be wound by a winding machine and stored and conveyed in a roll shape. The typically used winding machine may be used, and winding may be performed by a winding method such as a constant tension method, a fixed torque method, a tapered tension method or a program tension control method having constant internal stress.

<In-Plane Axial Fluctuation>

The optically compensatory film used in the present invention has an in-plane axial fluctuation of 1.0° or less, preferably 0.5° or less, more preferably 0.4° or less and even more preferably 0.3° or less. The in-plane axial fluctuation is ideally 0°. When the in-plane axial fluctuation exceeds 1.0°, (a phase difference which may not be assumed even in cross-Nicol arrangement occurs such that light leakage increases during black display, and thus) the fluctuation is not preferred.

<Haze Value>

The optically compensatory film used in the present invention has a total haze value of 1.0% or less, preferably 0.60% or less, more preferably 0.30% or less, even more preferably 0.25% or less, and most preferably 0.20% or less. The total haze value is ideally 0%. When the total haze value exceeds 1.0%, (the diffusion of light on the surface of the film and in the film is a factor for light leakage during black display, and thus) the total haze value is not preferred.

The total haze value (H) of the optically compensatory film can be measured in accordance with JIS K-7136, by using Haze Meter NDH2000 manufactured by Nippon Densyoku Industries Co., LTD., and so on.

The internal haze value is 0.50% or less, preferably 0.30% or less, more preferably 0.10% or less, even more preferably 0.05% or less and most preferably 0.03% or less. The total haze value is ideally 0%. When the internal haze value exceeds 0.50%, (the diffusion of light in the film is a factor for light leakage during black display, and thus) the internal haze value is not preferred.

<Optical Characteristics>

Preferred examples of the optically compensatory film used in the present invention are an optically compensatory film satisfying the conditions of nx>ny>nz, in which nx is a refractive index in an in-plane maximum direction, ny is a refractive index in a direction perpendicular to nx and nz is a refractive index in a thickness direction, in refractive indices in three directions of the optically compensatory film.

An in-plane retardation Re (=(nx-ny)×d; d represents a film thickness of a film) of the optically compensatory film is preferably from 1 nm to 200 nm, more preferably from 5 nm to 100 nm, even more preferably from 15 nm to 80 nm and particularly preferably from 30 nm to 60 nm, at a wavelength of 590 nm. A retardation in a thickness-direction Rth (={(nx+ny)/2−nz}×d; d represents a film thickness of a film) of the optically compensatory film is preferably from 80 nm to 400 nm, more preferably from 75 nm to 200 nm, even more preferably from 80 nm to 150 nm, and particularly preferably from 90 nm to 140 nm, at a wavelength of 590 nm.

<Film Thickness>

The film thickness of the optically compensatory film is not particularly limited, but is preferably from 10 μm to 200 μm. From the viewpoint of making the film thinner, a thinner film thickness is preferred, but when the film thickness is less than 10 μm, the handling property tends to be impaired. The film thickness is more preferably from 10 μm to 80 μm, even more preferably from 10 μm to 60 μm, particularly preferably from 10 μm to 50 μm, and most preferably from 10 μm to 40 μm.

In a preferred aspect in which the film has a three-layer structure of skin B layer/core layer/skin A layer and is sequentially high substitution layer/low substitution layer/high substitution layer, the average film thickness of the high substitution layer is preferably in a range of between 0.1 μm or more and less than 10 μm and more preferably in a range of between 0.5 μm or more and less than 5 p.m. When the skin layer is less than 0.1 μm thick, peeling property becomes insufficient, thereby easily causing stripe-shaped non-uniformity, film thickness irregularity or optical characteristic irregularity, of a film.

When the skin layer is 10 μm or more thick, the thickness of the core layer is limited in making the entire film thickness thinner, thereby making it difficult to effectively use the optical expression of the core layer.

<<Absorption Type Polarizing Plate>>

The optically compensatory film may be used as a protective film of an absorption type polarizing plate. An example of an absorption type polarizing plate which may be used in the present invention is a polarizing plate which includes a polarization film and two sheets of polarizing plate protective films which protect both sides thereof and has the optically compensatory film as a polarizing plate protective film on at least one side thereof. An optically compensatory film is disposed between a liquid crystal cell and a polarization film. When the optically compensatory film is used as a polarizing plate protective film, the optically compensatory film is preferably subjected to the surface treatment (also described in Japanese Patent Application Laid-Open Nos. 6-94915 and 6-118232) for hydrophilization, and for example, a glow discharge treatment, a corona discharge treatment, an alkali saponification treatment, or the like is preferably performed. Specifically, as the surface treatment, an alkali saponification treatment is used most preferably.

As the polarization film, a polarization film prepared by, for example, immersing a polyvinyl alcohol film in an iodine solution, stretching the film and the like may be used. When the polarization film prepared by immersing a polyvinyl alcohol film in an iodine solution and stretching the film is used, the surface treated side of the transparent optically compensatory film of the present invention may be attached directly to the polarization film by using an adhesion bond. As described above, it is preferred that the optically compensatory film of the present invention is directly attached to the polarization film. Examples of the adhesion bonds include aqueous solutions of polyvinyl alcohol or polyvinyl acetal (for example, polyvinyl butyral) or latexes of vinyl polymers (for example, polybutyl acrylate). An aqueous solution of completely saponified polyvinyl alcohol is a particularly preferred adhesion bond.

A liquid crystal display device generally has a liquid crystal cell disposed between two sheets of polarizing plates and therefore contains four polarizing plate protective films. Among the four protective films, the optically compensatory film may be used as a protective film disposed between the polarization film and the liquid crystal cell. Of course, the optically compensatory film may be used as a protective film disposed on a further outer side of the polarization film. On a protective film including the polarization film therebetween and disposed on the opposite side of the optically compensatory film, a transparent hard coat layer, an anti-glare layer, an antireflection layer and the like may be provided, and it is preferred that a protective film having these layers is used as a polarizing plate protective film of the outermost surface on the display side of the liquid crystal display device.

The transmission axis of the polarization film and the average slow axis of the optically compensatory film may be attached to each other while being in parallel with each other, and may be attached to each other while being perpendicular to each other. A polyvinyl alcohol (PVA)-based polarization film and the like generally has an absorption axis in the MD direction and a transmission axis in a TD direction. Thus, from the viewpoint of preparation suitability, when the MD direction is kept in synchronization and PVA-based polarization film having a long shape and the optically compensatory film having a long shape are attached to each other, it is preferred that the average slow axis uses the optically compensatory film in the TD direction in order to manufacture a polarizing plate of the former aspect and the average slow axis uses the optically compensatory film in the MD direction in order to manufacture a polarizing plate of the latter aspect. By disposing the transmission axis of the polarization film and the average slow axis of the optically compensatory film of the present invention in parallel to each other or perpendicularly to each other, excellent compensatory effects may be obtained without causing a phase difference which may not be assumed.

The film thickness of the polarization film is preferably from 5 μm to 30 μm, and particularly preferably from 10 μm to 25 μn.

There is no limitation on the protective film attached to the surface (that is, the surface to be the outer side of the polarization film when placed in a liquid crystal display device) on the other side of the polarization film. It is possible to use various polymer film such as, for example, cellulose acylate, polycarbonate-based polymers, polysterster-based polymers such as polyethylene terephthalate and polyethylene naphthalate, acrylic polymers such as polymethyl methacrylate, styrene-based polymers such as polystyrene or acrylonitrile-styrene copolymer (AS resin), and the like. One or two or more polymers are selected from polyolefins such as polyethylene and polypropylene and the like, cyclopolyolefins such as norbornene, and polyolefin-based polymers such as ethylene-propylene copolymer, vinyl chloride-based polymers, amide-based polymers such as nylon and aromatic polyamide, imide-based polymers, sulfone-based polymers, polyether sulfone-based polymers, polyether ether ketone-based polymers, polyphenylene sulfide-based polymers, chloride vinylidene-based polymers, vinyl alcohol-based polymers, vinyl butyral-based polymers, arylate-based polymers, polyoxymethylene-based polymers, epoxy-based polymers, polymer mixtures of the above polymers and the like, and the polymers are used as main components to prepare a polymer film, and thus the polymer film may be used as a protective film. A general purpose commercially available polymer film may also be used.

### EXAMPLE

Hereinafter, the present invention will be described in more detail based on Examples. The materials, amounts, ratios, operations, order of operations, and the like shown in Examples below may be appropriately modified without departing from the spirit of the present invention. Therefore, the scope of the present invention should not be construed as being limited by Examples shown below.

### Example 1

(Preparation of Resin Liquid 1)

The compound described below was mixed in a weight ratio described as follows, and then the mixture was stirred and mixed while being heated at 50° C. to obtain resin liquid 1.

EB3700: EBECRYL 3700, manufactured by DAICEL-UCB Company LTD.
Bisphenol A type epoxy acrylate (viscosity: 2200 mPa·s/65° C.), 60 parts by mass

BPE200: NK Ester BPE-200, manufactured by Shin-Nakamura Chemical Co., Ltd.
Ethylene oxide-added bisphenol A (meth)acrylic ester
(Viscosity: 590 mPa·s/25° C.), 20 parts by mass

BR-31: NEW FRONTIER BR-31, manufactured by DAI-ICHI KOGYO SEIYAKU CO., LTD.
Tribromophenoxy ethyl acrylate (solid at normal temperature, melting point 50° C. or more), 100 parts by mass

M-110: ARONIX M-110, manufactured by TOAGOSEI CO., LTD.
(Meth)acrylate of p-cumyl phenol reacted with ethylene oxide
(Viscosity: 150 mPa·s/25° C.), 20 parts by mass

Lucirin TPO-L (manufactured by BASF Corp.)
Ethyl-2,4,6-trimethylbenzoylethoxyphenyl phosphineoxide, 4 parts by mass

MEK: Methyl ethyl ketone, 68 parts by mass

(Preparation of Light Collecting Sheet 1)

On a triacetyl cellulose film (TD-80UF, manufactured by Fujifilm Corporation) having a film thickness of 80 μm, which is a transparent support, the prepared resin liquid 1 was coated by using a coater with a throttle die with the coating amount adjusted to obtain a thickness of 20 μm after drying, and drying was performed at 100° C. by a hot air circulation type drying apparatus.

Subsequently, the transparent support coated with the resin liquid was sandwiched between a nip roller and a concave convex roller at a nip pressure of 0.5 Pa to form a prism type unevenness pattern having a triangular apex portion and a triangular valley bottom on the resin layer, thereby manufacturing a transparent sheet. The formed pattern was a triangle with an apex angle of 90° on the apex portion and with a groove angle of 90° without a planar portion even on the valley bottom. The period was 50 μm and the depth was about 25 μm.

Thereafter, while wound and attached to the concave convex roller, the transparent sheet was exposed by a metal halide lamp to cure a film, and the film was peeled off from a metal mold to form light collecting sheet 1.

(Preparation of Phase Difference Film 1)

A commercially available triacetyl cellulose film (TD-80UL, manufactured by Fujifilm Corporation) having a film thickness of 80 μm was allowed to pass through a dielectric heating roll at a temperature of 60° C. to increase the surface temperature to 40° C., and then the alkaline solution having the composition shown below was coated at a coating amount of 14 ml/m² on the band surface of the film by using a bar coater. Under a steam-type far-infrared heater heated at 110° C., which is manufactured by Noritake Co., Ltd, the film was conveyed for 10 sec. Subsequently, pure water was coated thereon at 3 ml/m² by using a bar coater in the same manner as above. Subsequently, water washing performed by a fountain coater and water draining performed by an air knife were repeated three times, and then the film was conveyed and dried in a drying zone at 70° C. for 10 sec, thereby preparing a cellulose acylate film subjected to an alkali saponification treatment.

Composition of alkaline solution (parts by mass)

| | | |
|---|---|---|
| Potassium hydroxide | 4.7 | parts by mass |
| Water | 15.8 | parts by mass |
| Isopropanol | 63.7 | parts by mass |
| Surfactant SF-1: C₁₄H₂₉O(CH₂CH₂O)₂₀H | 1.0 | part by mass |
| Propylene glycol | 14.8 | parts by mass |

An aligned film coating liquid having the following composition was continuously coated on the above-saponified longitudinal cellulose acetate film at 23.5 mL/m² by using a #14 wire bar coater. Drying was performed with a warm air at 60° C. for 60 sec and further with a warm air at 100° C. for 120 sec.

| | |
|---|---|
| Composition of aligned film coating liquid | |
| Modified polyvinyl alcohol as described below | 10 parts by mass |
| Water | 371 parts by mass |
| Methanol | 119 parts by mass |
| Glutaraldehyde | 0.5 parts by mass |
| Photopolymerization initiator (lrgacure 2959, | 0.3 parts by mass |
| manufactured by Ciba Japan K.K.) | |

Modified polyvinyl alcohol

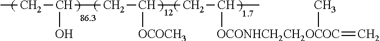

In the above structural formular, the ratio of each repeating unit is mass ratio.

The above-manufactured aligned film was continuously subjected to a rubbing treatment. At this time, the longitudinal direction and the conveyance direction of the longitudinal film were parallel to each other, and a rotation axis of a rubbing roller was inclined clockwise at 45° with respect to the film longitudinal direction.

Coating liquid A containing a discotic liquid crystal compound having the following composition was continuously coated on the above-manufactured aligned film by using a wire bar. A conveyance speed (V) of the film was set to 36 m/min. For the purpose of drying the solvent of the coating liquid and aging of alignment of the discotic liquid crystal compound, heating was performed with a warm air at 120° C. for 90 sec. Subsequently, UV irradiation was performed at 80° C. to fix the alignment of the liquid crystal compound and an optically anisotropic layer having a thickness of 1.77 μm was formed, thereby obtaining phase difference film 1. The manufactured phase difference film 1 has a Re (550) of 138 nm and a Rth (550) of −5 nm, at 550 nm. The direction of the slow axis is perpendicular to the rotation axis of the rubbing roller. That is, the slow axis was inclined counterclockwise at 45° with respect to the longitudinal direction of the support. The average tilt angle of a disc surface of the discotic crystalline molecules with respect to the film surface was 90°, and it was confirmed that the discotic liquid crystals were aligned perpendicular to the film surface. As Re (550) and Rth 500, values measured at a wavelength of 550 nm by using an automatic birefringence analyzer KOBRA-21 ADH (manufactured by Oji Scientific Instruments) were used. The moisture vapor permeability of the phase difference film per 24 hour at 40° C. and 90% RH was 330 g/m²/day.

| | |
|---|---|
| Composition of optically anisotropic layer coating liquid (A) | |
| Discotic liquid crystal compound as described below | 91 parts by mass |
| Acrylate monomer*1 | 5 parts by mass |
| Photopolymerization initiator (Irgacure 907, manufactured by Ciba Japan K.K.) | 3 parts by mass |
| Sensitizer (KAYACURE DETX, manufactured by Nippon Kayaku Co., Ltd.) | 1 part by mass |
| Pyridinium salt as described below | 0.5 parts by mass |
| Fluorine-based polymer (FP1) as described below | 0.2 parts by mass |
| Fluorine-based polymer (FP3) as described below | 0.1 parts by mass |
| Methyl ethyl ketone | 189 parts by mass |

*1: Ethylene oxide-modified trimethylolpropane triacrylate (V#360, manufactured by Osaka Organic Chemical Industry Ltd.)
Discotic liquid crystalline compound 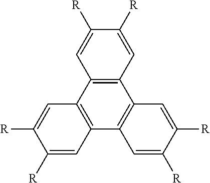 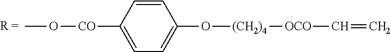
Pyridinium salt 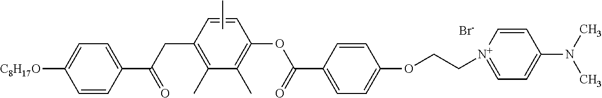
Flurorine-based polymer (FP1) 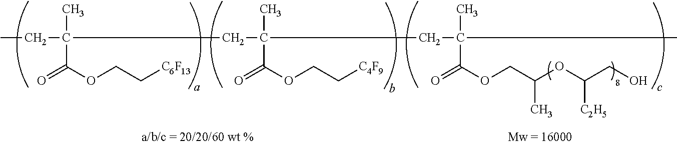
Flurorine-based polymer (FP3)

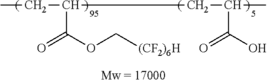

In the above structural formular, the ratio of each repeating unit is mass ratio.

(Preparation of Liquid Crystal Display Device 1)

The prepared light collecting sheet 1 and the phase difference film 1 were inserted into a liquid crystal display device LC-46LX1 manufactured by Sharp Corporation such that the position relationship of each member becomes the same arrangement as in FIG. 1, thereby manufacturing liquid crystal display device 1. As a surface light source, a reflection type polarizing plate, a liquid crystal cell, and a pair of absorption type polarizing plates, the same components incorporated into the liquid crystal display device LC-46LX1 Manufactured by Sharp Corporation were used.

### Comparative Example 1

Liquid crystal display device 2 is manufactured in the same manner as in Example 1, except that the light collecting sheet 2 formed of a transparent polyethylene terephthalate (PET) film having a thickness of 100 μm is used instead of the transparent support of light collecting sheet 1 manufactured in Example 1.

The configurations of the light collecting sheets and the liquid crystal display devices manufactured in the Examples and Comparative Examples were shown in Table 2 and Table 3, respectively.

TABLE 2

| | Material of | Re of | Refractive |
|---|---|---|---|
| | transparent | transparent | index of light |
| | support | support [nm] | collecting layer |
| Light collecting sheet 1 | TAC | 7 | 1.59 |
| Light collecting sheet 2 | PET | 5000 | 1.59 |

TABLE 3

| | Light collecting sheet | Phase difference film |
|---|---|---|
| Example 1 | Light collecting sheet 1 | Phase difference film 1 |
| Comparative | Light collecting sheet 2 | Phase difference film 1 |
| Example 1 | | |

[Display Performance Evaluation]

The luminance intensity of the prepared liquid crystal display device was measured at the front surface by using BM5A (manufactured by Topcon Corporation). The results are shown in Table 4. In Example 1 in which a film having a small Re was used as a transparent support of the light collecting sheet, a high luminance intensity may be obtained.

TABLE 4

| | Luminance intensity [cd/m²] |
|---|---|
| Example 1 | 500 |
| Comparative Example 1 | 480 |

### Example 2

(Manufacture of Optically Compensatory Film 1)

<Preparation of Cellulose Acylate Solution 1C>

Cellulose acylate and the compositions as described below were introduced into a mixing tank and stirred to dissolve each component, thereby preparing cellulose acylate solution 1C.

Composition of cellulose acylate solution 1C

| | | |
|---|---|---|
| Cellulose acylate CE-1 | 100.0 | parts by mass |
| Polyester oligomer A-1 | 10.0 | parts by mass |
| Methylene chloride (first solvent) | 403.0 | parts by mass |
| Methanol (second solvent) | 60.2 | parts by mass |

<Preparation of Cellulose Acylate Solution 1S>

Cellulose acylate and the compositions as described below were introduced into a mixing tank and stirred to dissolve each component, thereby preparing cellulose acylate solution 1S.

Composition of cellulose acylate solution 1S

| | | |
|---|---|---|
| Cellulose acylate CE-2 | 100.0 | parts by mass |
| Polyester oligomer A-1 | 5.0 | parts by mass |
| Methylene chloride (first solvent) | 403.0 | parts by mass |
| Methanol (second solvent) | 60.2 | parts by mass |

<Preparation of Mat Agent Solution 1>

Compositions as described below were introduced into a disperser and stirred to dissolve each component, thereby preparing mat agent solution 1.

Composition of mat agent solution 1

| | | |
|---|---|---|
| Silica particles having an average | 2.0 | parts by mass |
| particle size of 16 nm (AEROSIL R972, | | |
| manufactured by Nippon Aerosil Co., Ltd.) | | |
| Methylene chloride (first solvent) | 72.4 | parts by mass |
| Methanol (second solvent) | 10.8 | parts by mass |
| Cellulose acylate solution 1S | 10.3 | parts by mass |

CE-1: Degree of acetyl substitution 2.42, Total degree of substitution 2.42

CE-2: Degree of acetyl substitution 2.81, Total degree of substitution 2.81

TABLE 5
Polyester oligomer A-1

| Dicarboxylic | | | | |
|---|---|---|---|---|
| acid residue | Diol residue | | | |
| Terephthalic | Ethylene | Propylene | Both | Number average |
| acid | glycol | glycol | terminals | molecular weight |
| 100 mol % | 50 mol % | 50 mol % | Acetic acid | 900 |
| | | | capping | |

As a casting method, a three-layer co-casting was performed in sequence of dope for external layer (band layer)/dope for core layer/dope for external layer (air layer) by using a metal band casting machine, the dope was dried, and then a film was peeled off from the band by a peeling drum.

Cellulose acylate solution 1C was used as the dope for core layer, and a solution in which mat agent solution 1 was mixed in an amount of 1.35 parts by mass based on 100 parts by mass of cellulose acylate solution 1S was used as the dope for external layer.

The film having a residual solvent content of less than 1% was subjected to MD stretching at a stretching magnification of 1.05 times with a fixed end uniaxial stretching at an ambient temperature of 185° C., and then the film having a residual solvent content of less than 1% was subjected to TD stretching in a tenter zone at a stretching magnification of 1.30 times at an ambient temperature of 185° C.

Thereafter, the clip was peeled off and dried, thereby manufacturing optically compensator film 1 having a width of 2,000 mm. The manufactured optically compensatory film 1 had a residual solvent amount of 0.1% and a total film thickness of 50 μm (each of band layer and air layer had 2 μm in thickness).

An in-plane phase difference Re, a phase difference in a thickness direction Rth and a total haze of the obtained optically compensatory film were measured at a measurement wavelength of 550 nm by the method in the present specification. After the film was placed under measurement conditions of 25° C. and 60% relative humidity for a sufficient time, measurement was performed under this condition.

The results were shown in Table 6.

(Manufacture of Polarizing Plate 1)

Iodine was adsorbed on the stretched polyvinyl alcohol film to manufacture a polarization film.

Subsequently, the manufactured optically compensatory film 1 was adhered to one side of the polarization film by using a polyvinyl alcohol-based adhesion bond. At this time, optically compensatory film 1 was adhered to the polarization film such that the longitudinal direction of polyvinyl alcohol coincided with the longitudinal direction of optically compensatory film 1, and optically compensatory film 1 and the polarization film were disposed such that the slow axis of optically compensatory film 1 and the transmission axis of the polarization film were in parallel to each other.

In this manner, polarizing plate 1 was manufactured.

(Manufacture of Polarizing Plate 2)

Iodine was adsorbed on the stretched polyvinyl alcohol film to manufacture a polarization film.

Subsequently, cellulose-based film 1 which has not been subjected to TD stretching in the process of manufacturing optically compensatory film 1 was adhered to one side of the polarization film by using a polyvinyl alcohol-based adhesion bond. At this time, cellulose-based film 1 was adhered to the polarization film such that the longitudinal direction of polyvinyl alcohol coincided with the longitudinal direction of cellulose-based film 1.

In this manner, polarizing plate 2 was manufactured.

TABLE 6

| | Film thickness | Re | Rth | Total haze |
|---|---|---|---|---|
| | (μm) | (nm) | (nm) | (%) |
| Optically compensatory film 1 | 50 | 36 | 122 | 0.20 |
| Cellulose based film 1 | 65 | 4 | 51 | 0.24 |

The prism sheet for use in a backlight as described below was manufactured.

<Manufacture of Light Collecting Sheet Used in Example 2>

In the following manner, a prism sheet was manufactured.

[Preparation of Coating Liquid for Prism Layer]

A coating liquid for prism layer was prepared in accordance with the following prescription.

The composition described below was introduced into a mixing tank and stirred while heating at 50° C. to dissolve each component, thereby preparing a coating liquid. Meanwhile, the prism layer after curing had a refractive index of 1.59. A planar coating film was formed by the same liquid, and then the refractive index of the prism layer was measured by a prism coupler refractive index measurement device (SPA4000 Sairon Technology Inc.).

| | | |
|---|---|---|
| EBECRYL 3700(manufactured by DAICEL-UCB | 2.55 | parts by mass |
| Company LTD.) | | |
| NK Ester BPE-200(manufactured by Shin- | 0.85 | parts by mass |
| Nakamura Chemical Co., Ltd.) | | |
| ARONIX M-110(manufactured by TOAGOSEI | 0.85 | parts by mass |
| CO., LTD.) | | |
| NEW FRONTIER BR-31(manufactured by | 4.25 | parts by mass |
| DAI-ICHI KOGYO SEIYAKU CO., LTD.) | | |
| Methyl ethyl ketone | 2.89 | parts by mass |
| Lucirin TPO-L(manufactured by BASF Corp.) | 0.17 | parts by mass |

[Manufacture of Prism Sheet A]

The coating liquid for prism layer prepared in the above-described manner was coated to obtain a dry weight of 14 g/m² on a triacetyl cellulose film (TD-80UF, manufactured by Fujifilm Corporation) having a film thickness of 80 μm as a transparent support and dried at 80° C. for 1 min, and then the prism layer was then pressed against a mold formed of a metal (metal mold) having a stripe-like prism shape having a cross-sectional shape of an isosceles triangle with an apex angle of 90° and a pitch (bottom side length) of 50 μm engraved thereon. In this pressed state, the exposure was performed using a high-pressure mercury lamp from the side of a surface (second surface) located opposite to the side having the prism layer of the support, the film was cured and peeled off from the metal mold, and then prism sheet A (support having an unevenness portion formed thereon) was obtained.

<Preparation of Coating for White Reflective Layer>

A coating liquid for white reflective layer for forming an optical adjusting part was prepared in accordance with the following prescription.

[Composition of Mother Liquid for White Pigment Dispersion]

| | | |
|---|---|---|
| Polyvinyl butyral (S-LEC B BL-SH, | 2.7 | parts by mass |
| manufactured by SEKISUI CHEMICAL | | |
| CO., LTD.) | | |
| Rutile-type titanium oxide (JR805, | 35.0 | parts by mass |
| manufactured by Teyca Corp, mass | | |
| average particle size 0.29 μm) | | |
| Dispersion aid (Solsperse 20000, | 0.35 | parts by mass |
| manufactured by Avecia Corp.) | | |
| n-Propyl alcohol | 62.0 | parts by mass |

The composition was dispersed using zirconia beads by using a Motor Mill M50 manufactured by EIGER Corp. to prepare a mother liquid for white pigment dispersion.

<Composition of Coating Liquid for White Reflective Layer>

| | | |
|---|---|---|
| Mother liquid for white pigment dispersion | 1,200 | parts by mass |
| prepared in the above-described manner | | |
| Wax-based compound | | |
| Stearic acid amide | 5.7 | parts by mass |
| (Neutron 2, manufactured by Nippon Fine | | |
| Chemical Co., Ltd.) | | |
| Behenic acid amide (DIAMID BM, manufactured | 5.7 | parts by mass |
| by Nippon Kasei Chemical Co., Ltd.) | | |
| Lauric acid amide (DIAMID Y, manufactured | 5.7 | parts by mass |
| by Nippon Kasei Chemical Co., Ltd.) | | |
| Palmitic acid amide (DIAMID KP, manufactured | 5.7 | parts by mass |
| by Nippon Kasei Chemical Co., Ltd.) | | |
| Erucic acid amide (DIAMID L-200, manufactured | 5.7 | parts by mass |
| by Nippon Kasei Chemical Co., Ltd.) | | |
| Oleic acid amide (DIAMID O-200, manufactured | 5.7 | parts by mass |
| by Nippon Kasei Chemical Co., Ltd.) | | |
| Rosin (KE-311, manufactured by Arakawa | 80.0 | parts by mass |
| Chemical Industries, Ltd.; components: resin | | |
| acid from 80% to 97%; resin acid components: | | |
| abietic acid from 30% to 40%, neoabietic acid | | |
| from 10% to 20%, dihydroabietic acid 14% and | | |
| tetrahydroabietic acid 14%) | | |
| Surfactant (MEGAFAC F-780F, solid content | 16.0 | parts by mass |
| 30%, manufactured by DIC Co., Corporation) | | |
| n-Propyl alcohol | 1,600 | parts by mass |
| Methyl ethyl ketone | 580 | parts by mass |

<Manufacture of White Reflective Sheet>

A white reflective sheet was manufactured by coating the coating liquid for white reflective layer prepared in the above-described manner to a dry film thickness of 2 μm on a PET support having a thickness of 25 μm and drying at 100° C. for 2 min.

<Preparation of Coating Liquid for Positive Photosensitive Layer>

A coating liquid for positive photosensitive layer was prepared in accordance with the following prescription.

| | | |
|---|---|---|
| Phenol novolac resin (manufactured by | 2.5 | parts by mass |
| Sumitomo-Durez Co., Ltd., PR-50716, | | |
| melting point: 76° C.) | | |
| Phenol novolac resin (manufactured by | 3.5 | parts by mass |
| Sumitomo-Durez Co., Ltd., PR-51600B, | | |
| melting point: 55° C.) | | |
| 1,2-Naphthoquinone (2)diazido-4-sulfonic | 2.0 | parts by mass |
| acid cumyl phenol ester | | |
| Methyl ethyl ketone | 40 | parts by mass |
| Propylene glycol monomethyl ether acetate | 20 | parts by mass |
| Surfactant (manufactured by DIC Corporation, | 0.1 | part by mass |
| MEGAFAC F-176PF) | | |

0.1 part by mass

<Preparation of Alkali Liquid Developer>

An alkali liquid developer having the following composition was prepared.

| | | |
|---|---|---|
| Sodium carbonate | 59 | parts by mass |
| Sodium bicarbonate | 32 | parts by mass |
| Water | 720 | parts by mass |
| Butyl cellosolve | 1 | part by mass |

<Optical Sheet Having Light Collecting Properties: Manufacture of Prism Sheet B>

As illustrated in FIG. 8, the coating liquid for positive photosensitive layer prepared in the above-described manner was coated on the side of the planar second surface 4 of prism sheet A (support 2 having unevenness portion 5 formed thereon) to a dry film thickness of 0.5 μm and dried at 100° C. for 2 min to form a positive photosensitive layer 8 on the second surface 4 of the support 2.

Subsequently, as illustrated in FIG. 9, the positive photosensitive layer was exposed by irradiation with UV ray in a direction parallel to the direction of the normal line of the planar second surface 4 by using a parallel beam irradiation device (Mask Alignment Device M-2L, manufactured by MIKASA Co., Ltd.) from the side of the first surface 3 having the unevenness portion 5 of the support 2 formed thereon. A portion shown as reference numeral 6 in FIG. 9 is a non-passage portion (portion having a low light flux density) of light.

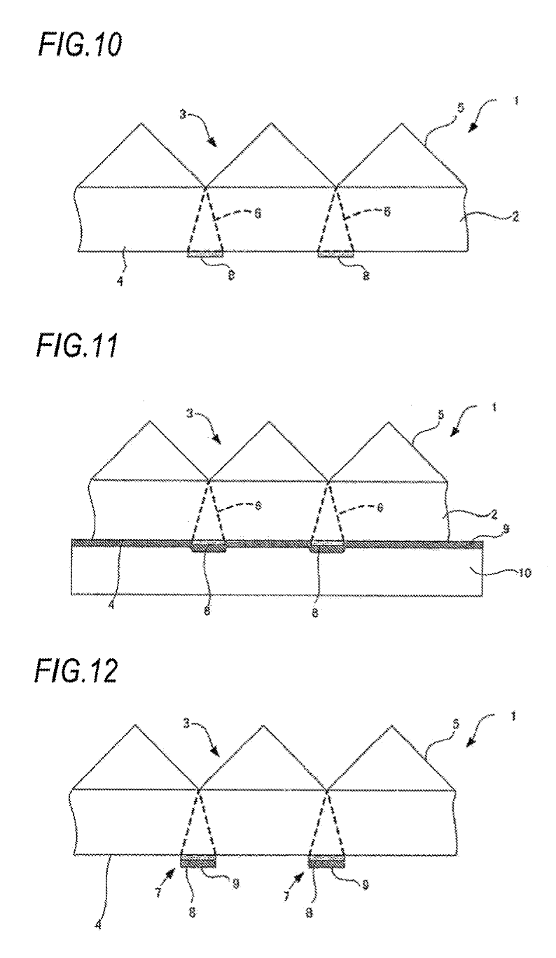

Subsequently, the exposed portion of the positive photosensitive layer was washed out using the alkali liquid developer prepared in the above-described manner, and the support 2 partially having the positive photosensitive layer 8 at the non-passage portion of light 6 on the second surface 4 was obtained, as illustrated in FIG. 10.

As illustrated in FIG. 11, the white reflective sheet 10 having the white reflective layer 9 formed thereon, which is manufactured in the above-described manner, was disposed on the second surface 4 of the support 2 partially having the positive photosensitive layer 8 such that the white reflective layer 9 was in contact with the positive photosensitive layer 8 having adhesiveness at the second surface 4, and heat laminate (speed: 0.5 m/min, heating temperature: 80° C.) was performed with a laminate device. Thereafter, as illustrated in FIG. 12, the white reflective sheet 10 was peeled off from the support 2 to obtain the support 2 on which the white reflective layer 9 was transferred in a stripe shape with a width of 12 μm on the formation portion of the positive photosensitive layer 8, thereby forming prism sheet B. The white reflective layer 9 was a side lobe preventive portion 7, and the light reflectance thereof was 71%.

[Manufacture of Prism Sheet C]

The prism layer coating liquid prepared in the above-described manner was coated to obtain a dry weight of 14 g/m² on a triacetyl cellulose film (TD-80UF, manufactured by Fujifilm Corporation) having a film thickness of 80 μm as a transparent support and dried at 80° C. for 1 min, and then the prism layer was then pressed against a mold formed of a metal (metal mold) having a stripe-like prism shape having an isosceles triangular cross-sectional shape with an apex angle of 110° and a pitch (bottom side length) of 50 μm engraved thereon. In this pressed state, the exposure was performed using a high-pressure mercury lamp from the side of the second surface of the support, the film was cured and peeled off from the metal mold, and then prism sheet C (support having an unevenness portion formed thereon) was obtained.

<Manufacture of Backlight Unit>

A backlight unit was manufactured such that a surface light source and a reflection type polarizing plate detached from a commercially available liquid crystal display device, phase difference film 1 manufactured in Example 1, and each prism sheet as described above have the same arrangement as the arrangement in FIG. 1.

The manufactured prism sheet A with an apex angle of 90°, light prism sheet B, which was a prism sheet with an apex angle of 90°, had the plurality of side lobe preventive portions 7 partially having optical reflective properties formed thereon, and was a light collecting optical sheet, and prism sheet C with an apex angle of 110° were disposed as in the configuration in Table 8.

Meanwhile, a reflecting plate was disposed on the bottom surface of the surface light source commonly used, and thus a constant improvement in light use efficiency was shown even without a prism sheet.

<Evaluation Method of Front Surface Luminance Intensity>

A luminance intensity meter (BM-7: TOPCON CORPORATION) was installed on a planar light source of each backlight unit in which the prism sheet was installed to measure light intensity. When only a backlight planar light source was installed without a prism sheet and the front surface luminance intensity at that time was taken as 1, evaluation of the luminance intensity was performed by using a magnification of the front surface luminance intensity when the prism sheet was placed, and then the results are classified as follows.

A: 1.5 or more

B: 1.3 or more and less than 1.5

C: 1.1 or more and less than 1.3

D: Less than 1.1

<Measurement of Exit Angle Distribution of Backlight Light>

For the backlight unit installed with the prism sheet, light intensity was measured by a luminance intensity meter (BM-7: TOPCON CORPORATION).

The front surface was set as 0°, the light collecting direction of the prism sheet was scanned by a light receiver until 85° by 5° to measure the angle distribution of intensity of light exiting from the prism sheet, an average value of light amount measured in a range of from 50° to 85° in exit angle was obtained, and the results were shown in Table 8.

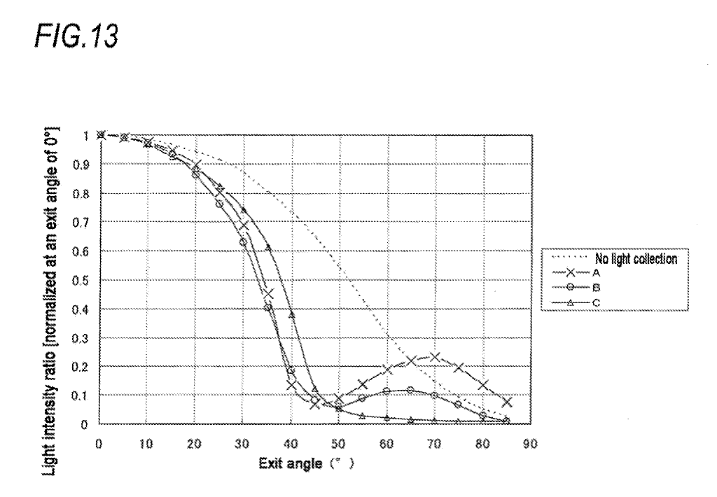

Meanwhile, a relationship between light intensity and exit angle based on a light intensity (cd) measured at the front surface (0°) with respect to each prism sheet was normalized, and the results are illustrated in FIG. 13.

<Manufacture of Liquid Crystal Display Device>

A liquid crystal display device (displays 20 to 28) was assembled such that the liquid crystal cell and the polarizing plate were configured as in Table 7 and a backlight unit into which each prism sheet was incorporated was configured as in Table 8.

A commercially available product LS-XL2370KF in TN mode manufactured by Samsung Electronics Co., Ltd. was used as the liquid crystal cell, a long side direction of the screen was taken as a horizontal direction and a short side direction thereof was taken as vertical direction, and a polarizing plate was exchanged with the above-described polarizing plate 1 or polarizing plate 2 and attached thereon. At this time, each polarizing plate was arranged at E-mode (which is a configuration that an alignment direction of a liquid crystal molecular on a support is parallel to the transmission axis of the polarizing plate being in contact therewith).

Each prism sheet was disposed to face the convex portion to the side of the liquid crystal cell, and the light collecting direction thereof was disposed to be the vertical direction or horizontal direction as described in Tables 7 and 8.

<Evaluation Method of on-Axis Contrast>

The on-axis contrast of the liquid crystal display device (displays 20 to 28) in Tables 7 and 8 was evaluated.

A contrast measurement device (manufactured by ELDIM Corporation, EZContrast) was used under the environment of 25° C., 60% RH to measure the on-axis contrast.

As the evaluation criteria, the relative ratios for the on-axis contrast values of display 25 as the Comparative Example were used and the evaluation was performed as in the following criteria.

A: on-axis contrast relative ratio is 1.15 or more

B: on-axis contrast relative ratio is 1.10 or more and less than 1.15

C: on-axis contrast relative ratio is 1.05 or more and less than 1.10

D: on-axis contrast relative ratio is less than 1.05 The evaluation results of front surface luminance intensity and on-axis contrast are shown in Table 8.

For the performance of displays 22 and 23 with optically compensatory film 1 used in the polarizing plate and prism sheets B and C disposed such that the light collecting direction becomes the vertical direction, the front surface luminance intensity was high and the on-axis contrast was also excellent.

TABLE 7

| | Polarizing | Polarizing | | |
|---|---|---|---|---|
| | plate on | plate on | | |
| | the visual | the backlight | Adhesion | |
| | recognition side | side | direction | Remark |
| Display 20 | Polarizing | Polarizing | E-mode | Compartive |
| | plate 1 | plate 1 | | Example |
| Display 21 | | | | Example |
| Display 22 | | | | Example |
| Display 23 | | | | Example |
| Display 24 | | | | Example |
| Display 25 | Polarizing | Polarizing | E-mode | Compartive |
| | plate 2 | plate 2 | | Example |
| Display 26 | | | | Example |
| Display 27 | | | | Example |
| Display 28 | | | | Example |

TABLE 8

| | Prism sheet | | | Performance | | |
|---|---|---|---|---|---|---|
| | | | 50-80° | Front | On- | |
| | | Light | Average | surface | axis | |
| | | collecting | light | luminance | con- | |
| | Sheet | direction | amount | intensity | trast | Remark |
| Display 20 | — | — | 23% | D | D | Com- |
| | | | | | | partive |
| | | | | | | Example |
| Display 21 | A | Vertical | 16% | B | C | Example |
| Display 22 | B | Vertical | 7.2% | A | B | Example |
| Display 23 | C | Vertical | 2.0% | C | A | Example |
| Display 24 | C | Horizontal | 2.0% | C | C | Example |
| Display 25 | — | — | 23% | D | D | Com- |
| | | | | | | partive |
| | | | | | | Example |
| Display 26 | A | Vertical | 16% | B | C | Example |
| Display 27 | B | Vertical | 7.2% | A | C | Example |
| Display 28 | C | Vertical | 2.0% | C | C | Example |

What is claimed is:

1. A liquid crystal display device comprising:
a liquid crystal cell sandwiched between a pair of absorption type polarizing plates;
a reflection type polarizing plate;
a phase difference film;
a light collecting sheet; and
a surface light source,
wherein the liquid crystal cell sandwiched between a pair of absorption type polarizing plates, the reflection type polarizing plate, the phase difference film, the light collecting sheet, and the surface light source are disposed in this order from a display surface side, and
the phase difference film has a λ/4 function and the light collecting sheet is formed of a refractive index isotropic material.

2. The liquid crystal display device according to claim 1,
wherein the light collecting sheet comprising:
a transparent support; and
a light collecting layer,
wherein an in-plane retardation Re (550) of the transparent support at a wavelength of 550 nm is 20 nm or less.

3. The liquid crystal display device according to claim 2,
wherein the light collecting layer has a refractive index of 1.55 or more.

4. The liquid crystal display device according to claim 1,
wherein a retardation Rth (550) in a thickness direction of the phase difference film is from −90 nm to 90 nm.

5. The liquid crystal display device according to claim 1,
wherein at least one surface of the phase difference film has a random unevenness.

6. The liquid crystal display device according to claim 5,
wherein the random unevenness of the phase difference film has an average tilt angle θa of from 2° to 5°.

7. The liquid crystal display device according to claim 1,
wherein when measuring the amount of light exiting from a backlight unit including the reflection type polarizing plate, the phase difference film, the light collecting sheet and the surface light source, with respect to the normal line of a display screen of the liquid crystal display device, an average value of the amounts of light at an exit angle in the range of from 50° to 85°, which is inclined to the vertical direction or horizontal direction when the liquid crystal display screen is visually recognized by an observer, is 12% or less based on the amount of light in the direction of the normal line.

8. The liquid crystal display device according to claim 7,
wherein each of the absorption type polarizing plates include a polarizing film sandwiched by two protective films,
at least one of the protective films which are provided between the liquid cell and the polarizing films of the absorption type polarizing plates is an optically compensatory film, and
an in-plane retardation Re (550) of the optically compensatory film is from 1 nm to 200 nm, and a retardation Rth (550) in a thickness direction is from 80 nm to 400 nm.

9. The liquid crystal display device according to claim 7,
wherein the liquid crystal cell is in a TN mode.
